(19) United States
(12) Patent Application Publication
(10) Pub. No.: US 2008/0138785 A1
(43) Pub. Date: Jun. 12, 2008

(54) Method And System for Evaluating Student Progess

(76) Inventor: Pamela Latreace Pearson, Kansas City, MO (US)

Correspondence Address: LATHROP & GAGE LC, 2345 GRAND AVENUE, SUITE 2800, KANSAS CITY, MO, 64108, US

(21) Appl. No.: 11/844,977

(22) Filed: Aug. 24, 2007

Related U.S. Application Data
(60) Provisional application No. 60/840,315, filed on Aug. 25, 2006.

(51) Int. Cl. G09B 3/00

(52) U.S. Cl. 434/353

(57) ABSTRACT

A method and system for evaluating the progress of a student. Initially, achievement data for the student, including classes of data comprising behavioral data, grade data, reading proficiency data, and standardized test score data, is processed to generate an individual achievement index score for each of the classes of data. A learning profile for the student is then built from the index score data. The behavioral data and the grade data are together classified as social data, and the reading proficiency data and the standardized test score data are together classified as academic data. The social data and the academic data are weighted in accordance with respective predetermined multipliers to generate corresponding social and academic index scores for the student.

### RELATED APPLICATION

This application claims benefit and is a nonprovisional application of U.S. Patent Application Ser. No. 60/840,315, filed Aug. 25, 2006. The disclosure of which is incorporated herein.

### TECHNICAL FIELD

The disclosed subject matter is directed to an electronic and computerized system, and method for evaluating the progress of students based on administrative, including academic, and socially observed data.

### BACKGROUND

Computerized processes for monitoring school students look at various aspects of a students performance. For example, these computerized systems typically work with academic data, such as grades for academic subjects and administrative data, such as attendance figures, race, number of other children in the family, all fixed values. As a result of these fixed values, the only evaluations are statistical, and many other criteria, essential to evaluating a student are missed or ignored, as there is no known way to quantify these values.

### SUMMARY

The disclosed method and system is used in evaluating the progress of a student, and typically multiple individual students. The system includes, at least one database for being stored in data storage, the at least one database comprising, raw data compiled from administrative criteria and assessment criteria, and manufactured data, derived from the raw data, and at least two computer programs. There is a first computer program for obtaining certain of the raw data and processing it into manufactured data, and, a second computer program for processing the manufactured data into an index score corresponding to the progress of the student. The system is such that the administrative criteria is determined from objective factors and the assessment criteria is determined from subjective factors.

### BRIEF DESCRIPTION OF THE DRAWINGS

Attention is now directed to the drawings, where corresponding or like numerals or characters indicate corresponding or like components. In the drawings:

FIG. 1A is a diagram of the disclosed system in an exemplary operation;

FIG. 1B is a diagram of the Front Desk System or Student Data Archive (SDA);

FIG. 1C is a diagram of the Genkofa Learning Profile (GLP);

FIG. 2 is a flow diagram of the Front Desk System or Student Data Archive (SDA);

FIGS. 3A and 3B are a diagram of the files that are included in the SDA database of FIGS. 1A and 1B;

FIG. 4 is a diagram of the files that are included in the SDA database of FIGS. 1A and 1C;

FIG. 5 is a flow diagram for the Genkofa Learning Profile, from which the index score of the disclosed system and method is obtained in order to evaluate each student for whom data has been entered;

FIGS. 6-8 are screen displays (screen shots) that appear on the monitor of a user's computer as per the flow diagram of FIG. 5;

FIG. 9 is a flow diagram for building individual achievement data;

FIG. 10 is a flow diagram for creating a score or value for attendance of FIG. 9;

FIG. 11 is a flow diagram for creating a score or value for attendance rate trend of FIG. 10;

FIG. 12 is a flow diagram for creating a score or value for parent/guardian volunteer hours of FIG. 10;

FIG. 13 is a flow diagram for creating a score or value for parent/guardian volunteer hours trend of FIG. 12;

FIG. 14 is a flow diagram for creating a score or value for disciplinary incidents of FIG. 10;

FIG. 15 is a flow diagram for creating a score or value for disciplinary incidents trend of FIG. 14;

FIG. 16 is a flow diagram for building grading data of FIG. 9, and including creating a score or value for grading (GPA);

FIG. 17 is a flow diagram for creating a score or value for grading trends of FIG. 16;

FIG. 18 is a flow diagram for building reading data of FIG. 9, and including creating a score or value for SRI;

FIGS. 19A and 19B are is a flow diagram for creating a score or value for SRI trend of FIG. 18;

FIG. 20 is a flow diagram for building reading data of FIGS. 9 and 18, and including creating a score or value for DRP;

FIGS. 21A and 21B are is a flow diagram for creating a score or value for DRP trend of FIG. 20;

FIG. 22 is a flow diagram for building educational data of FIG. 9, and creating a score or value for MAP Math;

FIG. 23 is a flow diagram for creating a score or value for MAP Social Science of FIG. 22;

FIG. 24 is a flow diagram for creating a score or value for MAP Science of FIG. 22;

FIG. 25 is a flow diagram for creating a score or value for MAP Communication Art of FIG. 22;

FIG. 26 is a flow diagram for creating a score or value for SAT Reading of FIG. 22;

FIGS. 27A and 27B are a flow diagram for creating a score or value for SAT Reading Trend of FIG. 26;

FIG. 28 is a flow diagram for creating a score or value for SAT Math of FIG. 22;

FIGS. 29A and 29B are a flow diagram for creating a score or value for SAT Math Trend of FIG. 28;

FIG. 30 is a flow diagram for creating a score or value for SAT Science of FIG. 22;

FIGS. 31A and 31B are a flow diagram for creating a score or value for SAT Science Trend of FIG. 30;

FIG. 32 is a flow diagram for creating a score or value for SAT Social Science of FIG. 22;

FIGS. 33A and 33B are a flow diagram for creating a score or value for SAT Social Science Trend of FIG. 32;

FIG. 34 is a flow diagram for calculating the individual achievement index or index score of FIG. 5;

FIG. 35 is a flow diagram for calculating the individual achievement index or index score of FIG. 34;

FIGS. 36A-36C are flow diagrams for creating a score or value for A1 of FIG. 35;

FIG. 37 is a flow diagram for creating a score or value for A2 of FIG. 35;

FIG. 38 is a flow diagram for creating a score or value for A3 of FIG. 35;

FIGS. 39A-39C are a flow diagram for creating a score or value for A4 of FIG. 35;

FIG. 40 is a flow diagram for building individual profiles based on the index score from FIG. 35, from FIG. 5;

FIGS. 41 and 42 are flow diagrams for building the components of FIG. 40;

FIG. 43 is a screen display of the Individual Achievement Index or Index Score, from FIG. 5; and,

FIGS. 44A and 44B are one or more screen displays of a report (of FIG. 43) with the index score generated by the disclosed system and method.

This document is also accompanied by three appendices, Appendix A, Appendix B, and Appendix C.

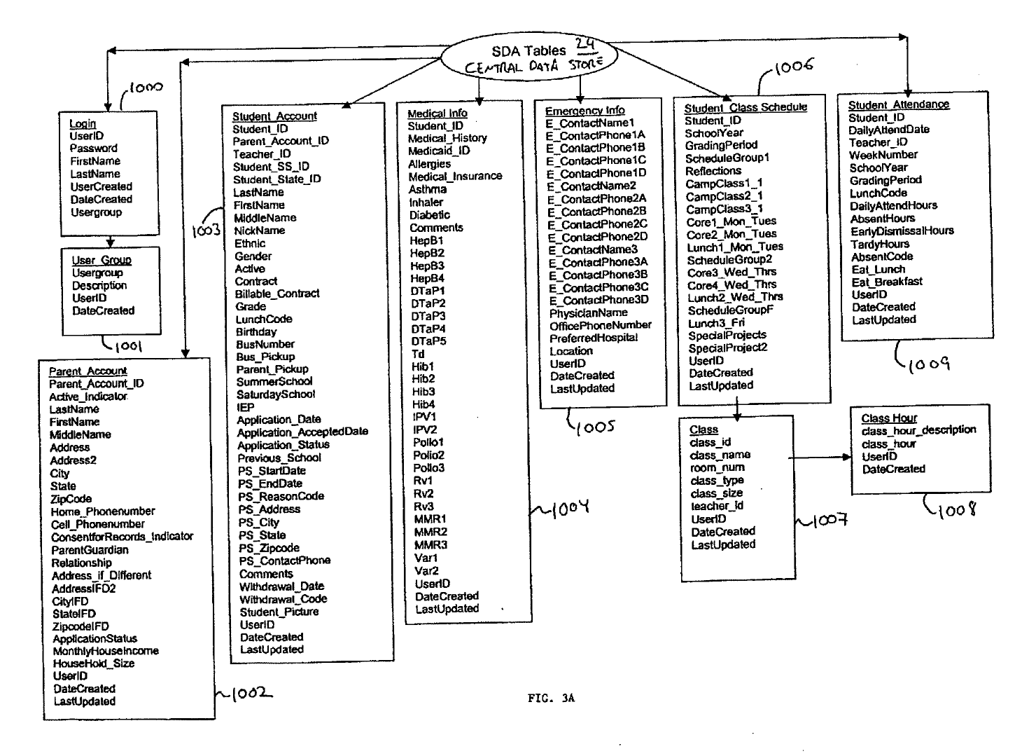

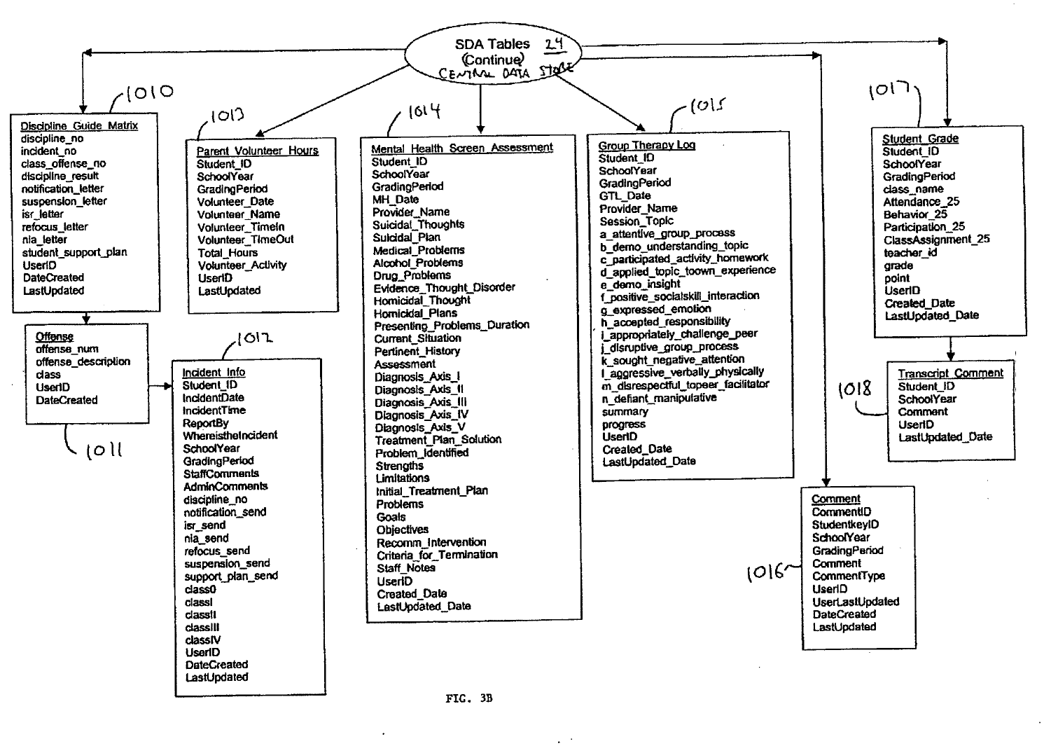

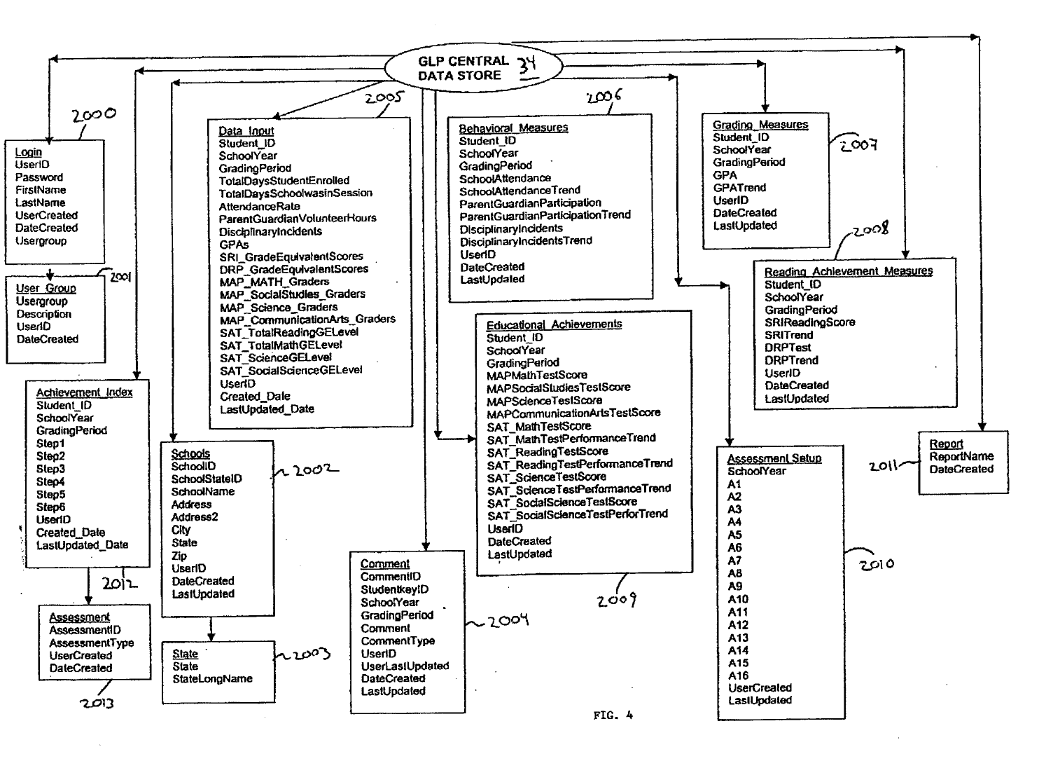

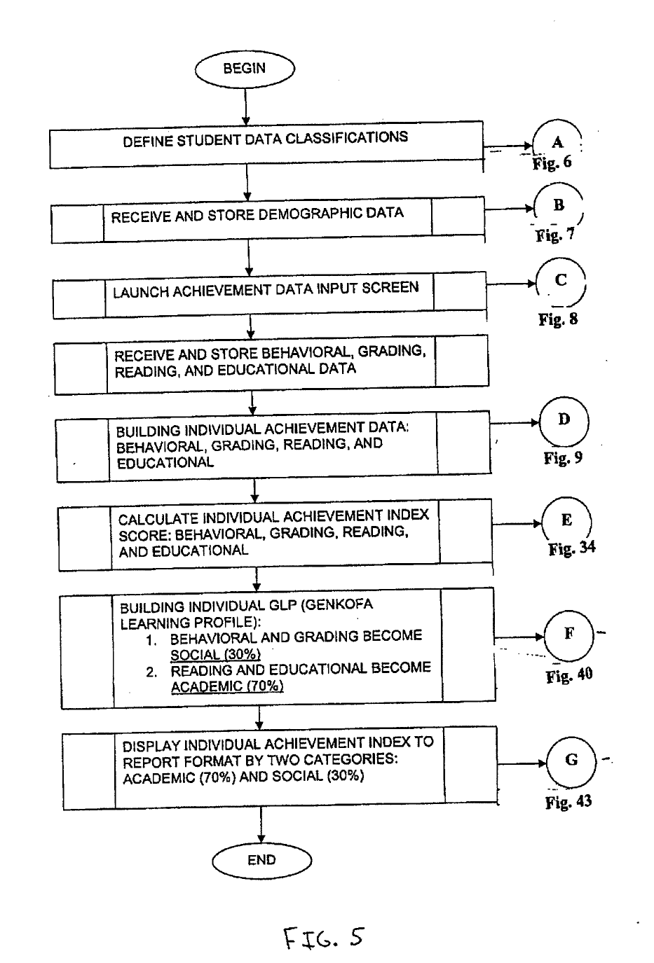

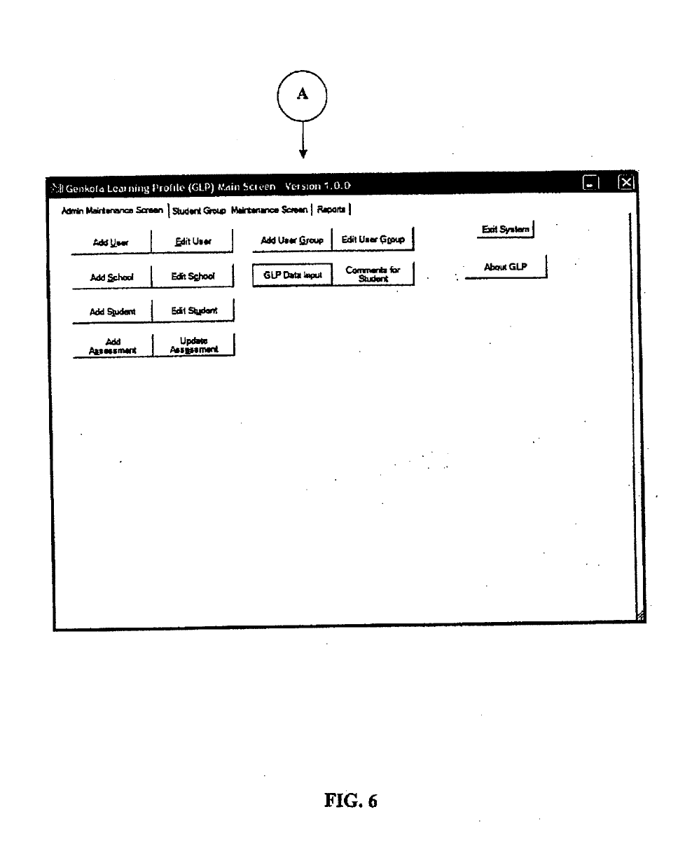

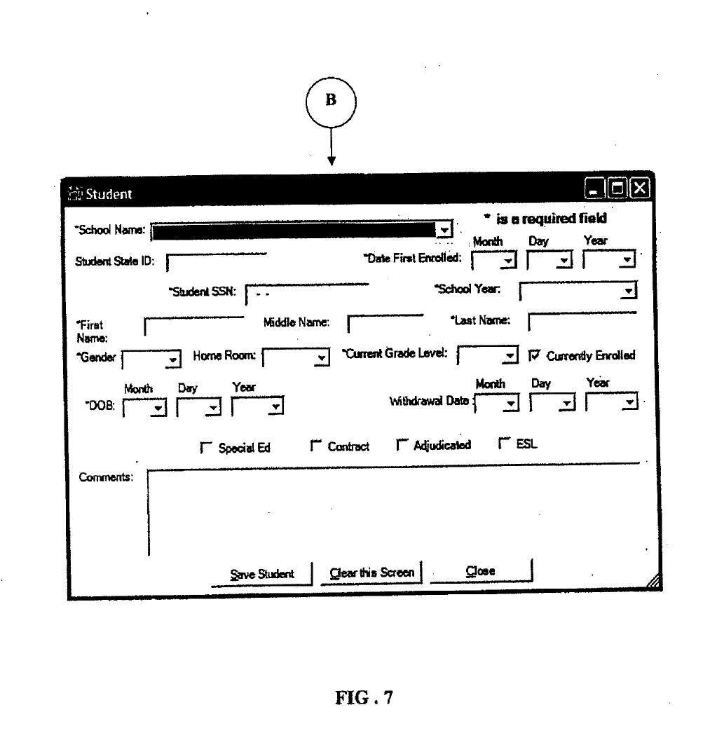

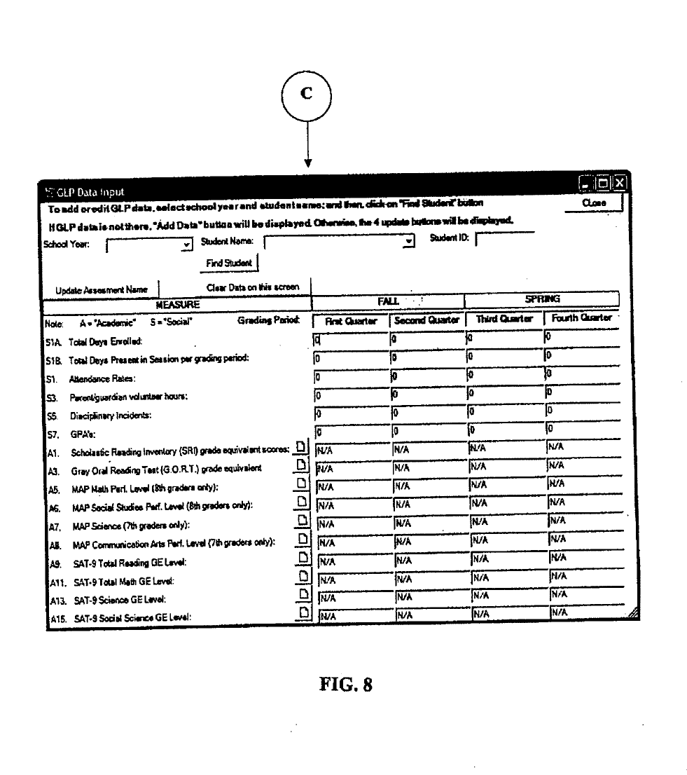

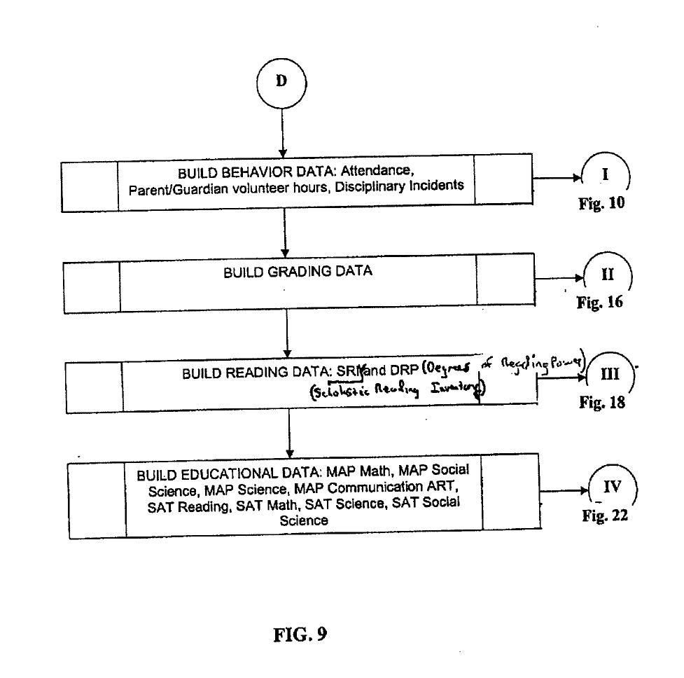

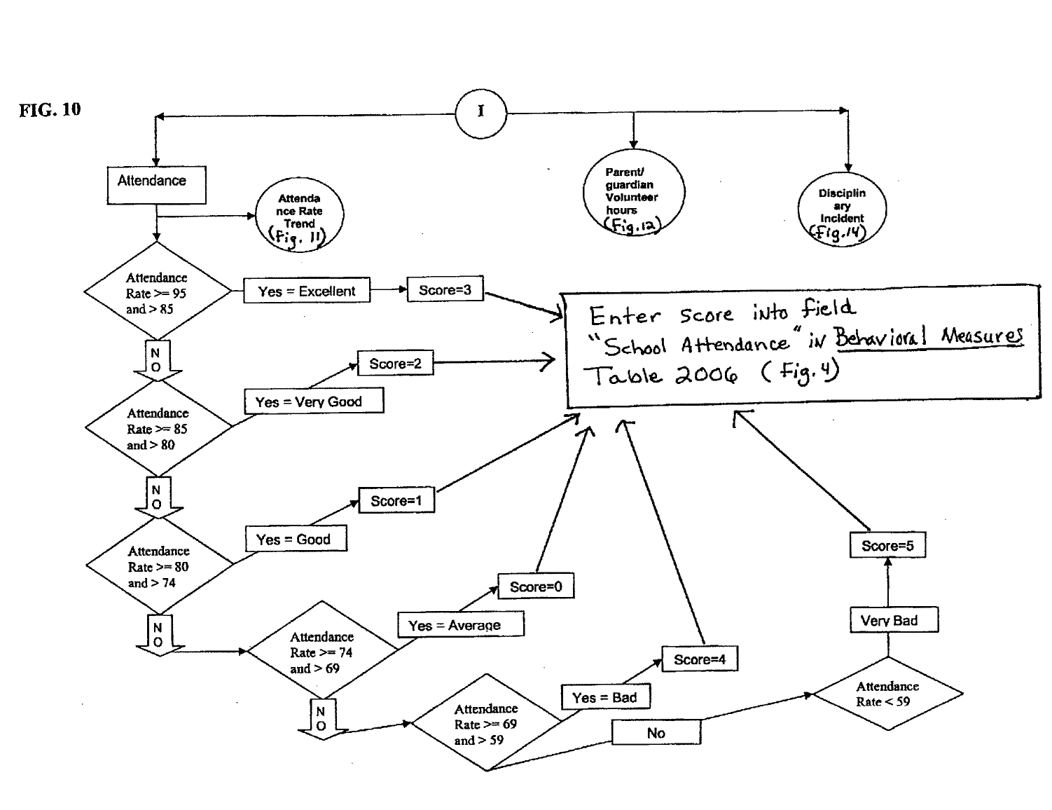

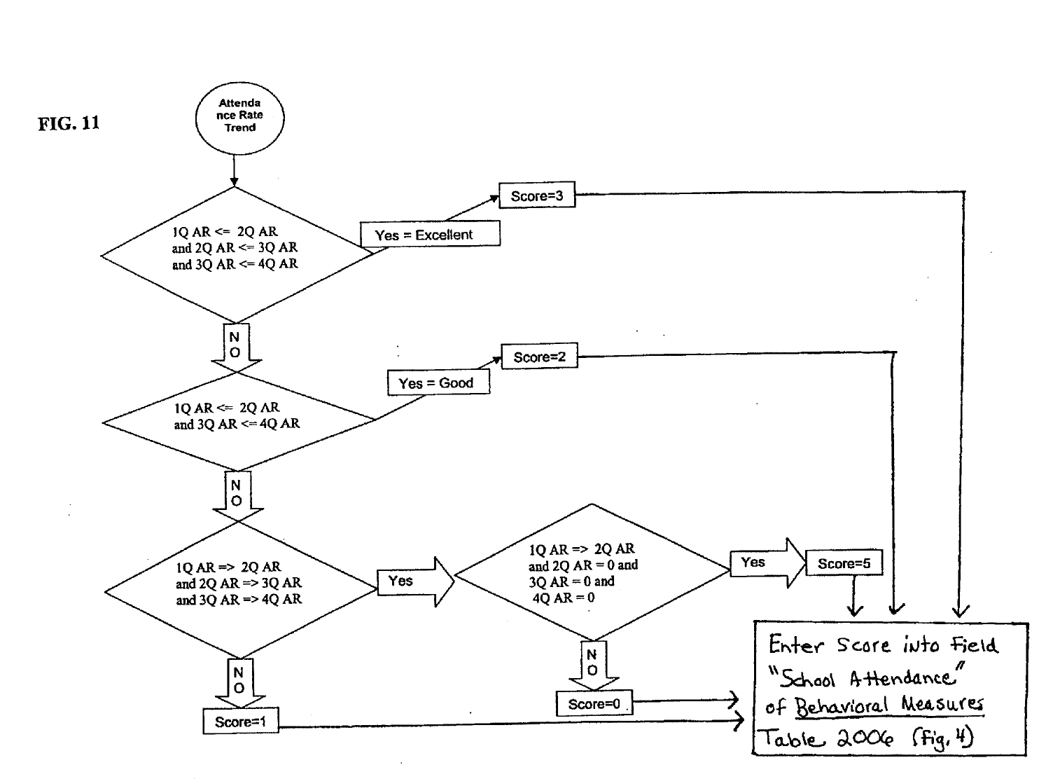

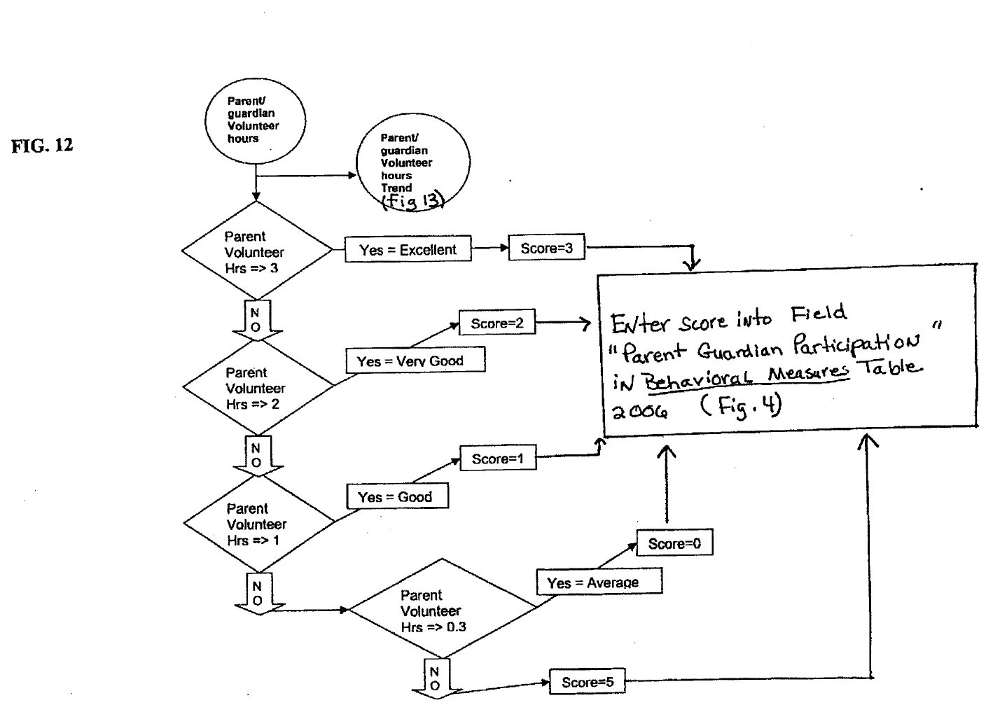

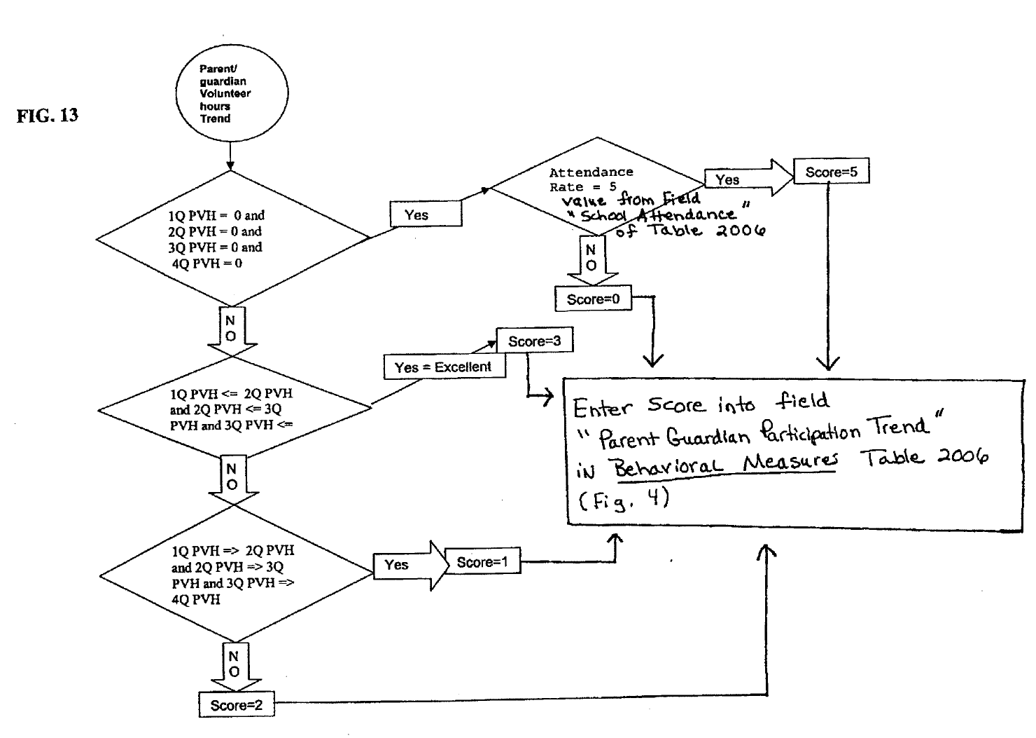

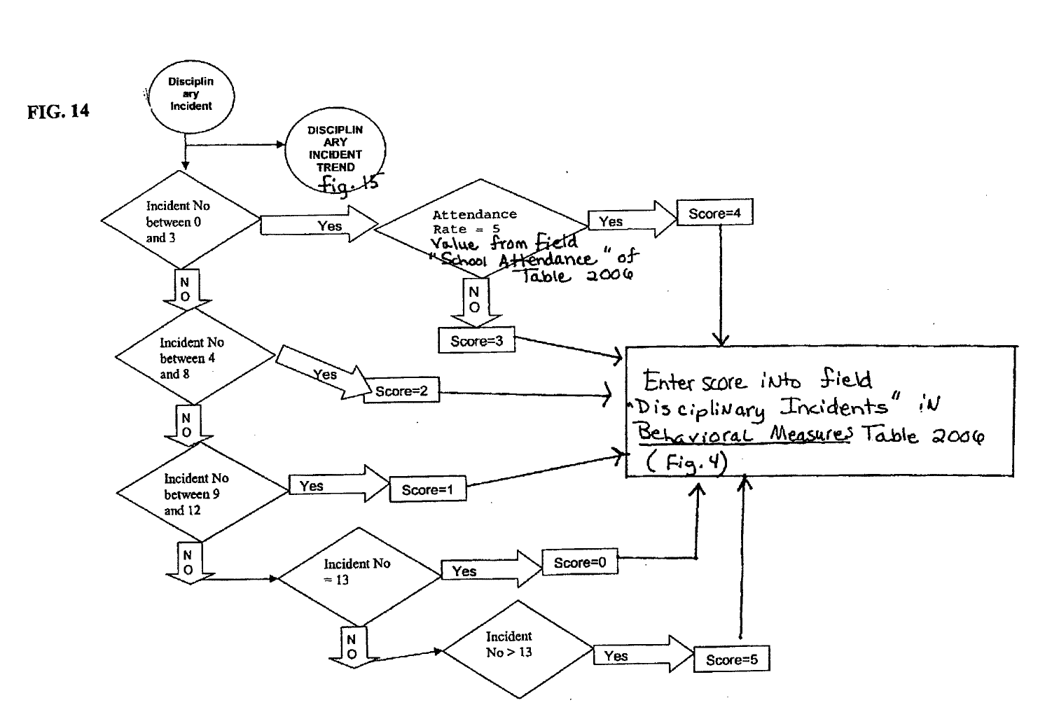

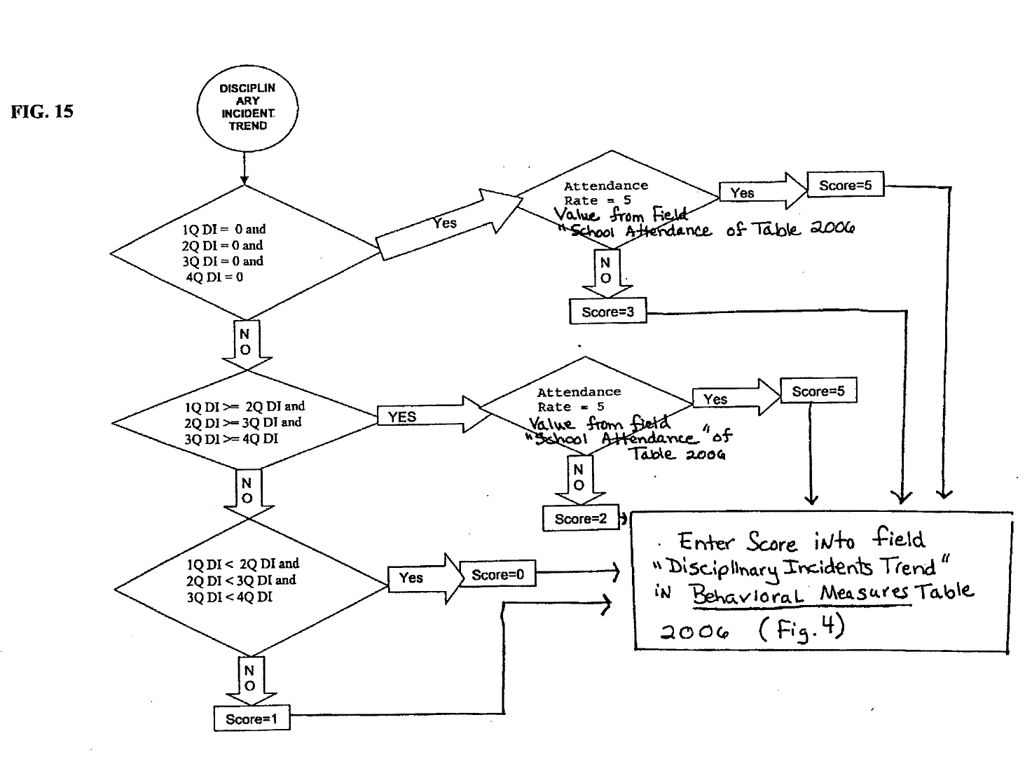

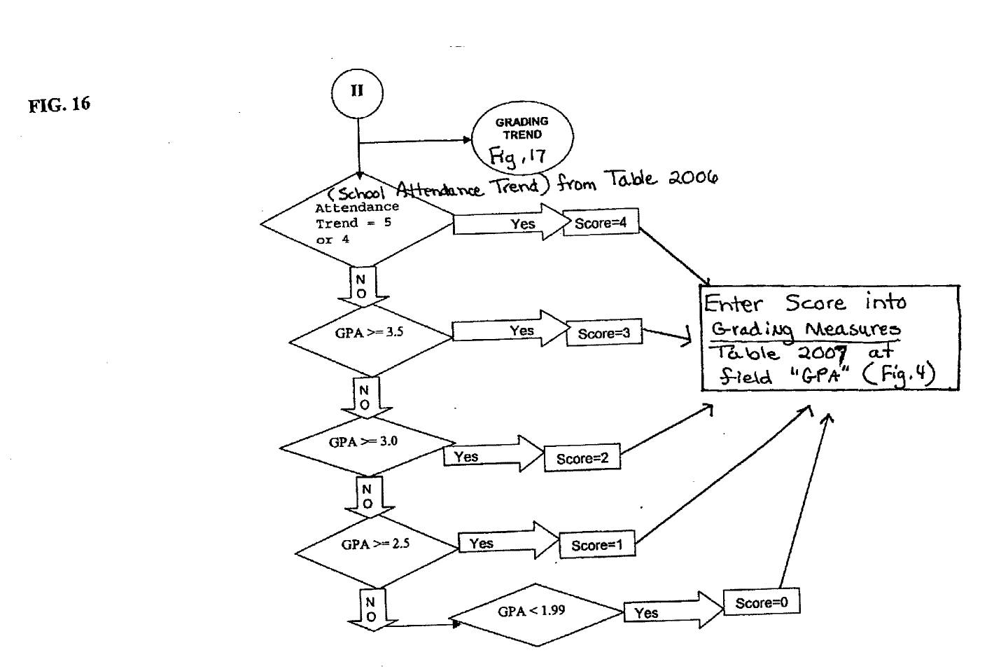

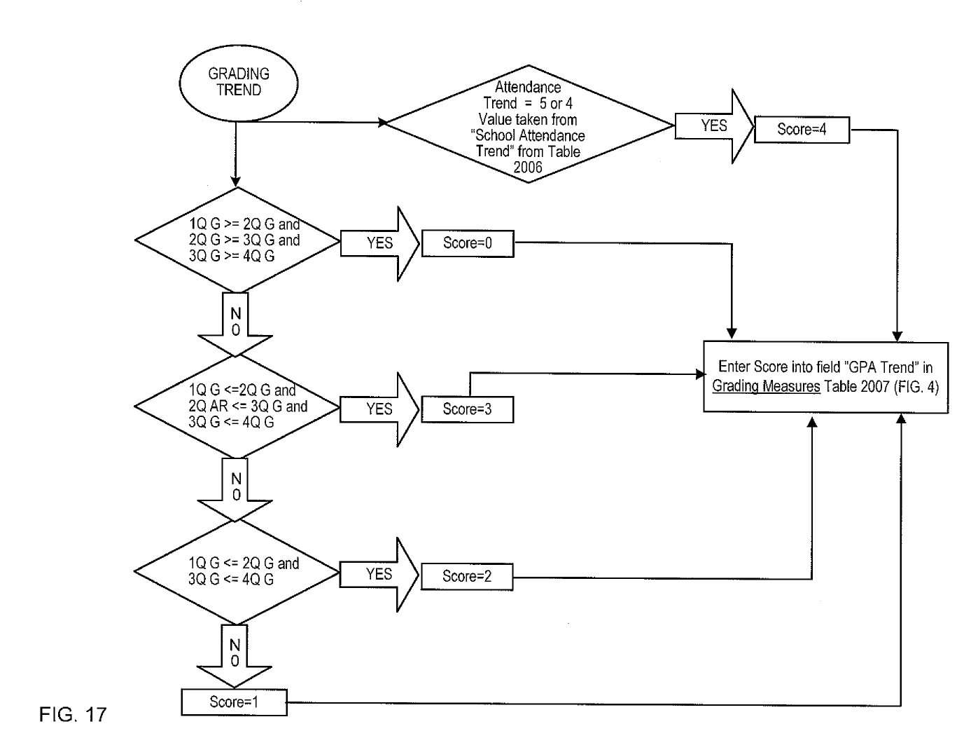

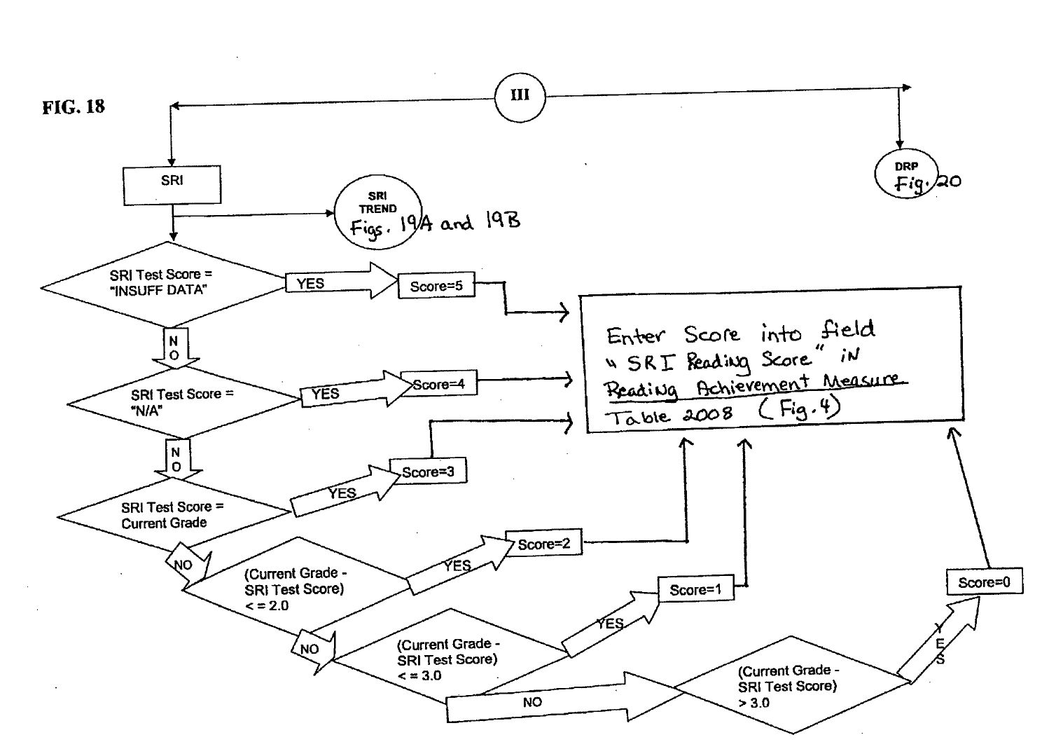

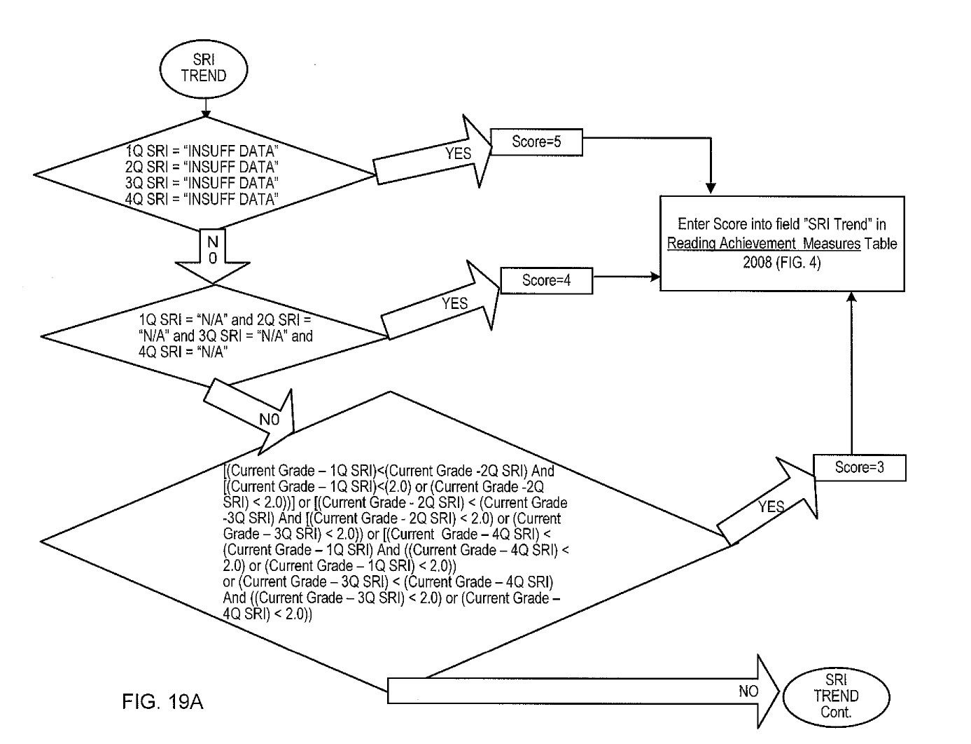

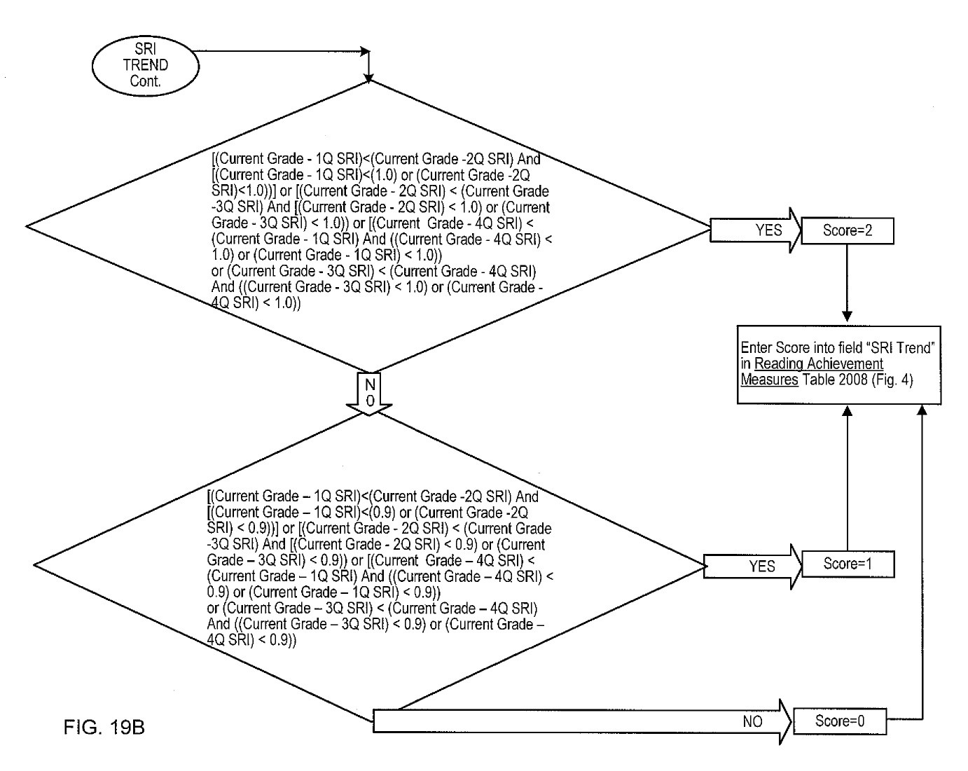

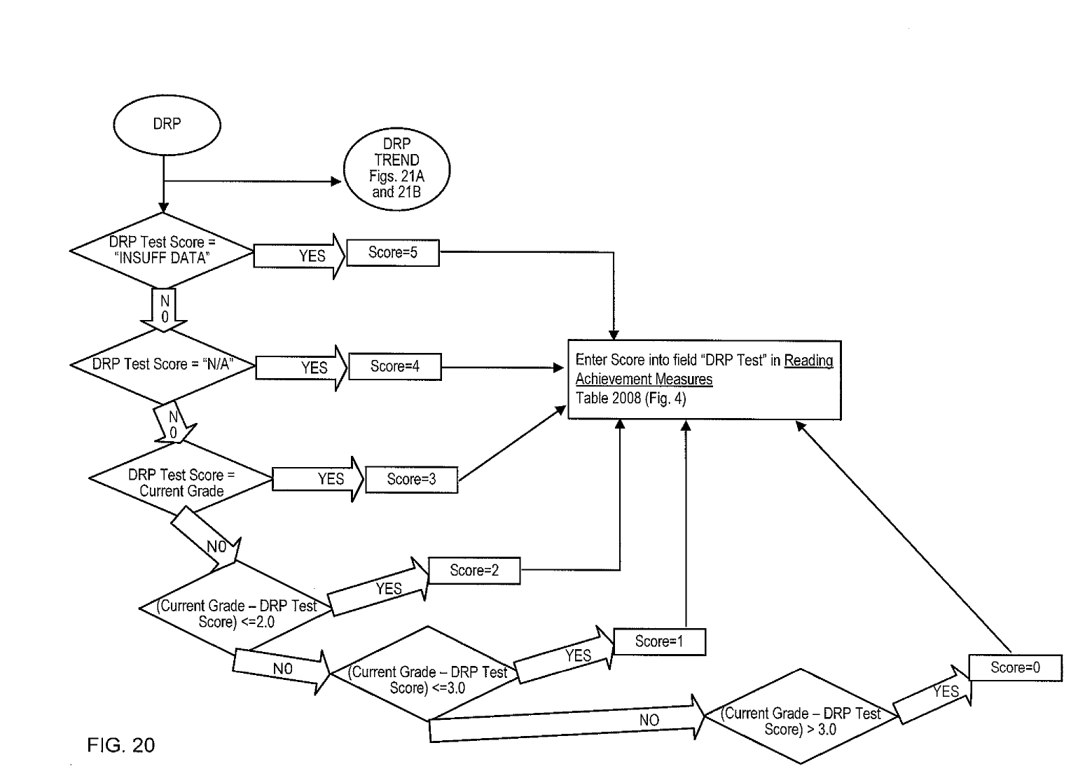

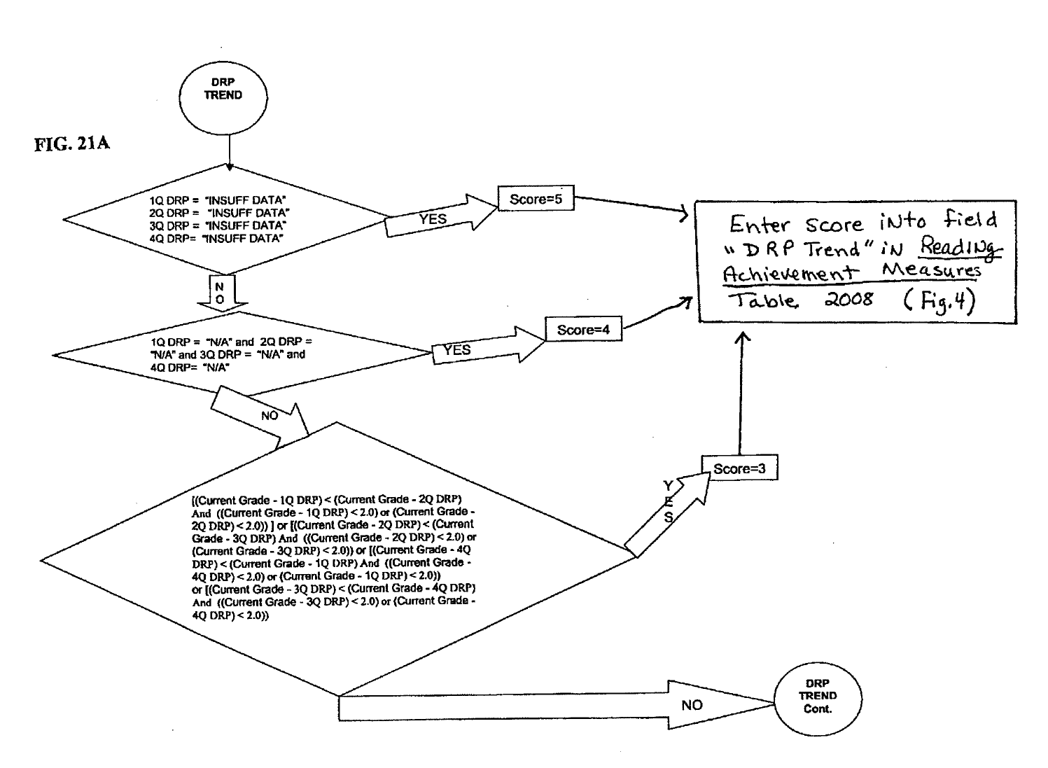

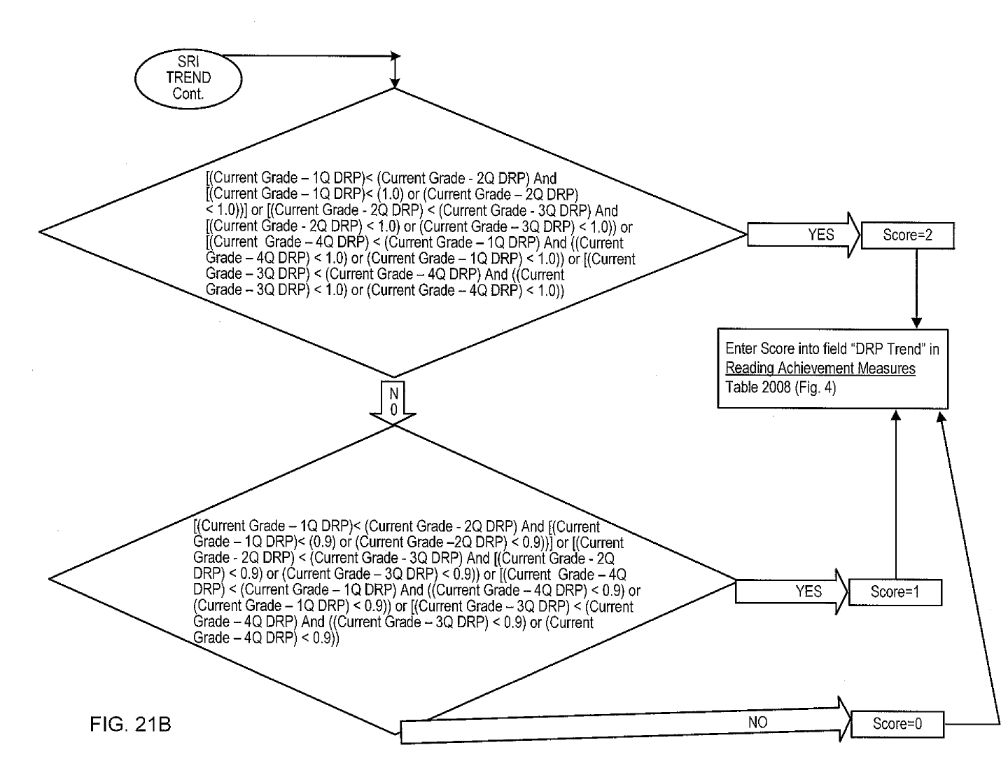

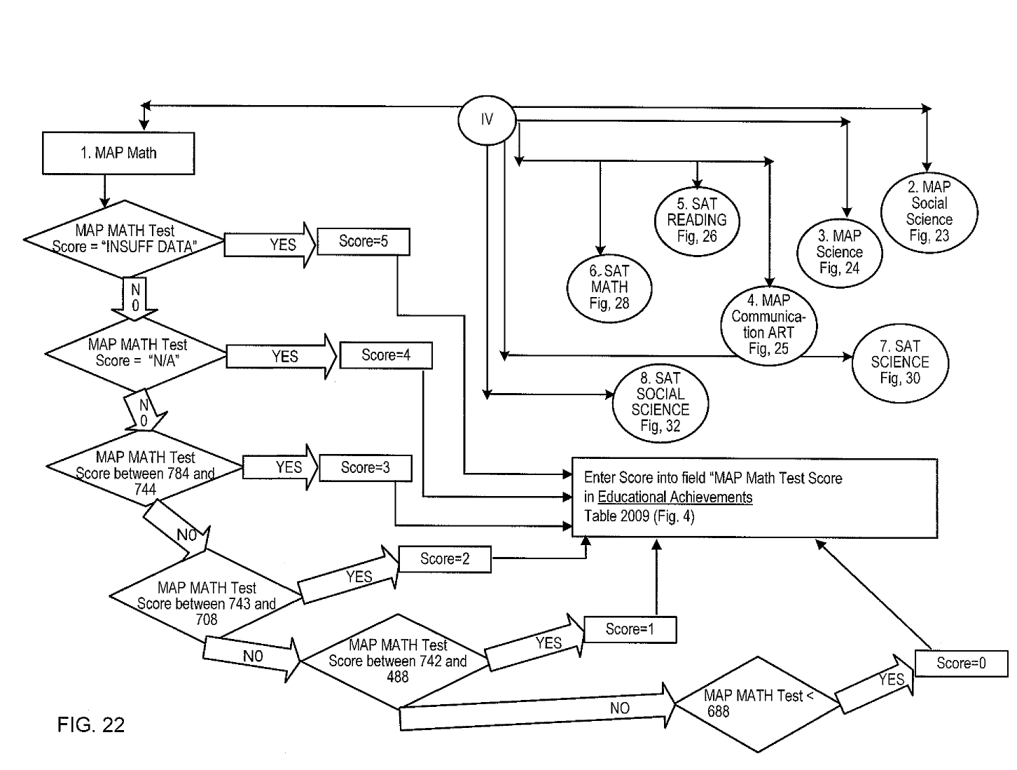

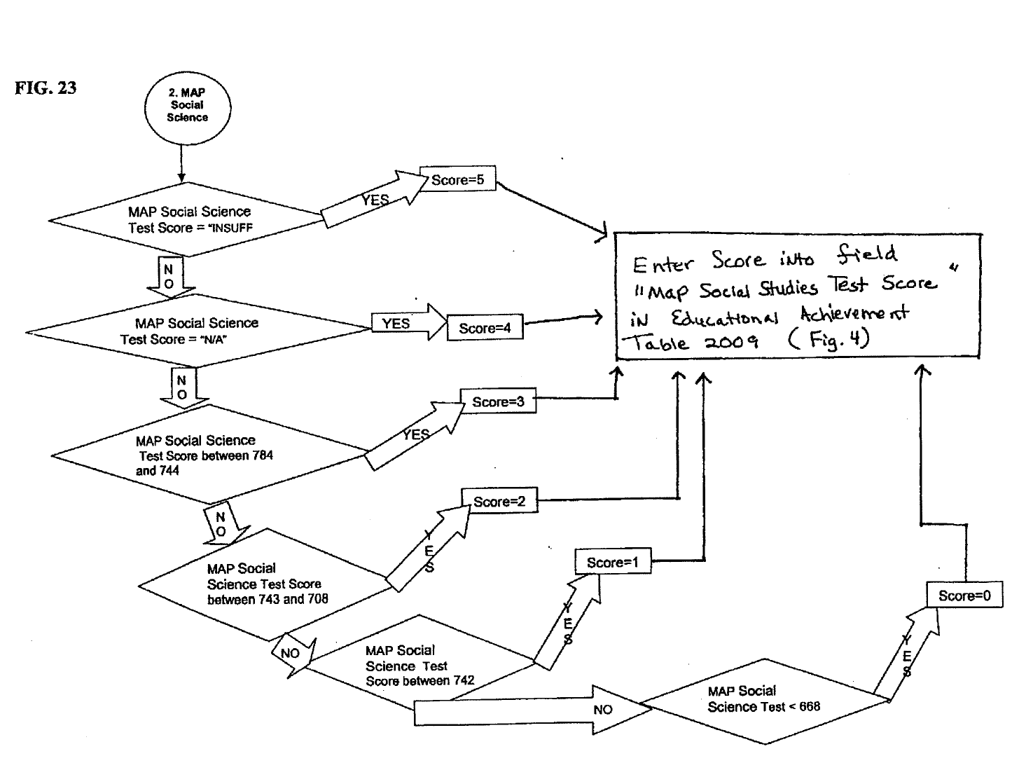

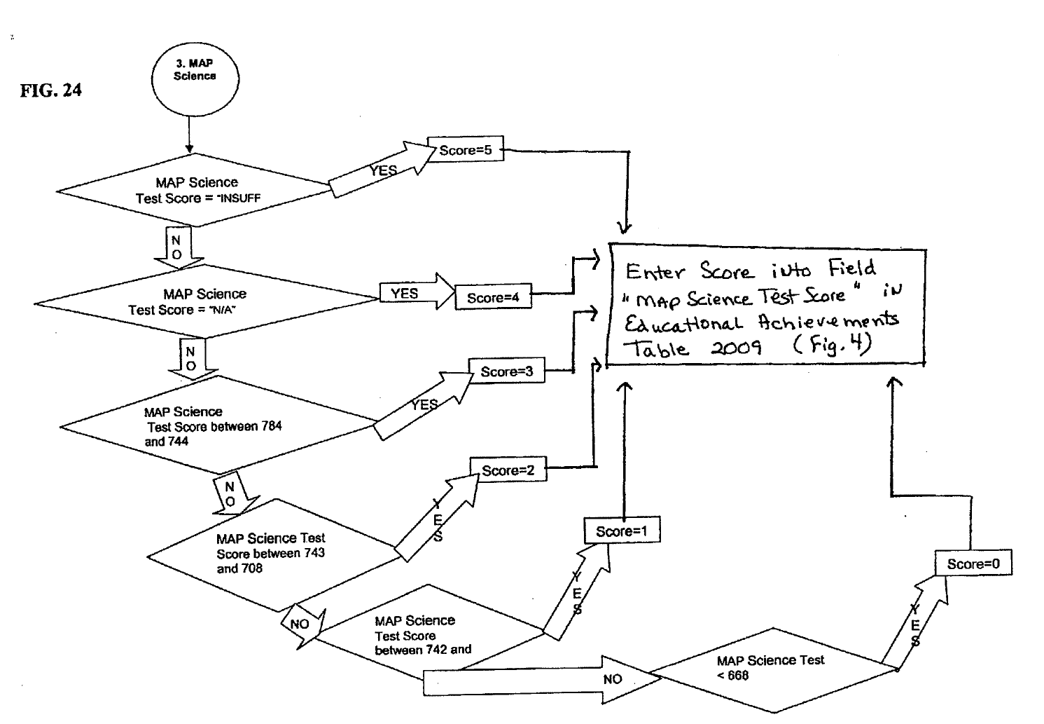

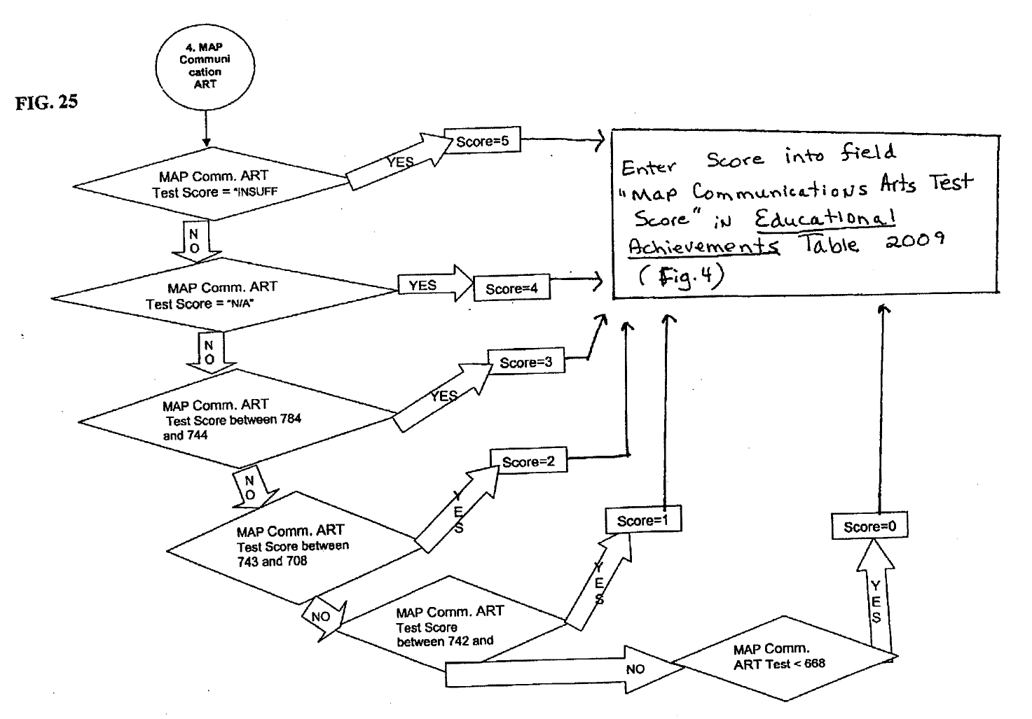

Appendix A is an listing of the fields for each file 1000-1018 (FIG. 3) for the SDA database 24 of FIGS. 3A and 3B, and each file 2000-2013 for the GLP database 34 of FIG. 4. Appendix A is 37 sheets.

Appendix B is entitled: SDA User Manual, for the front desk system. Appendix B is 29 sheets.

Appendix C is entitled: GLP User Manual. Appendix C is 24 sheets.

### DETAILED DESCRIPTION

The presently disclosed subject matter overcomes problems with contemporary systems, by providing data for social development, in addition to an administrative, for example, academic, profile on a student, to determine the student's progress. The system includes a front desk system where administrative data is entered into the system and a profiling system, where the administrative data from the front desk system is used both raw and with further processed or manufactured data, to arrive at a score, also known as an “index score” for a student, from which his progress is determined. The system also provides for showing trends in student progress, including trends in various aspects of the process. The system is unique in that the index score accounts for incomplete, unavailable and non-applicable data to calculate an index score relative to all other index scores calculated.

Throughout this document, textual and graphical references are made to actual trademarks and fictitious Internet addresses (Uniform Resource Locators, also known as URLs). The aforementioned trademarks and Internet addresses are for explanation purposes only, and any association with any party or other entity is coincidental, unintentional and unrelated thereto. All trademarks are the property of their respective owners, and are referenced only for explanation purposes herein.

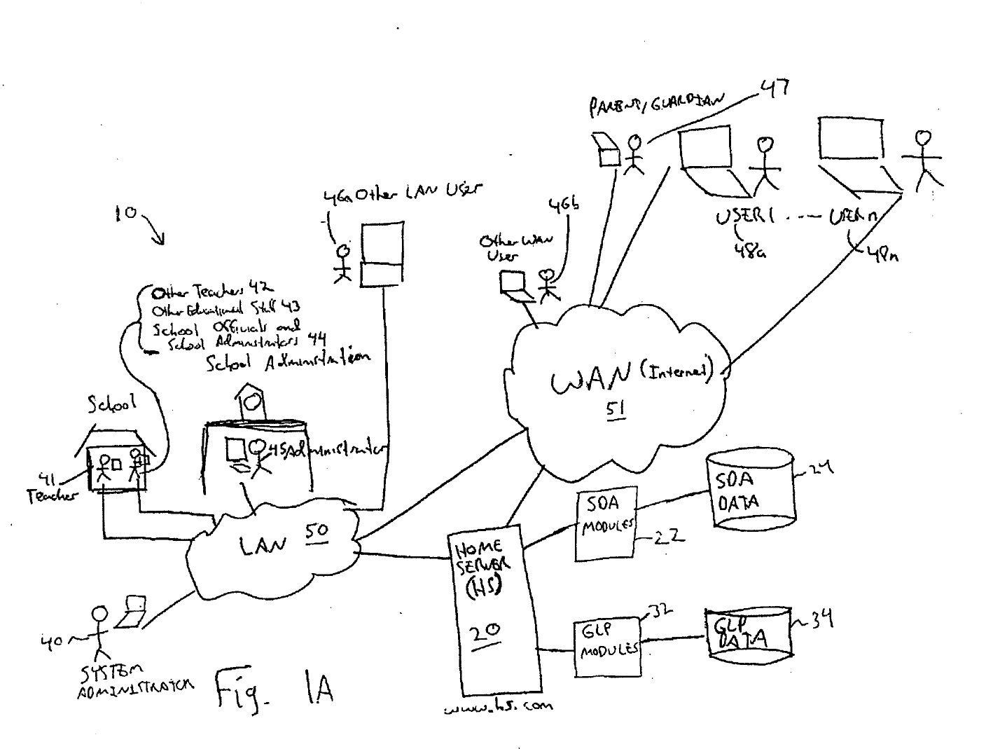

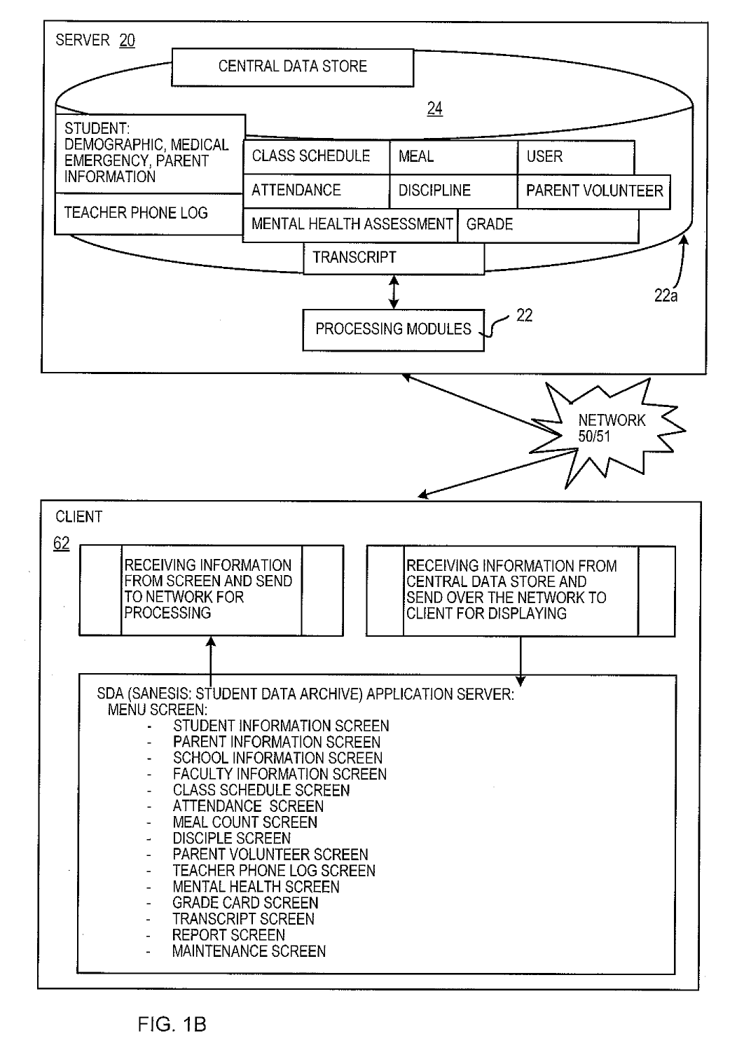

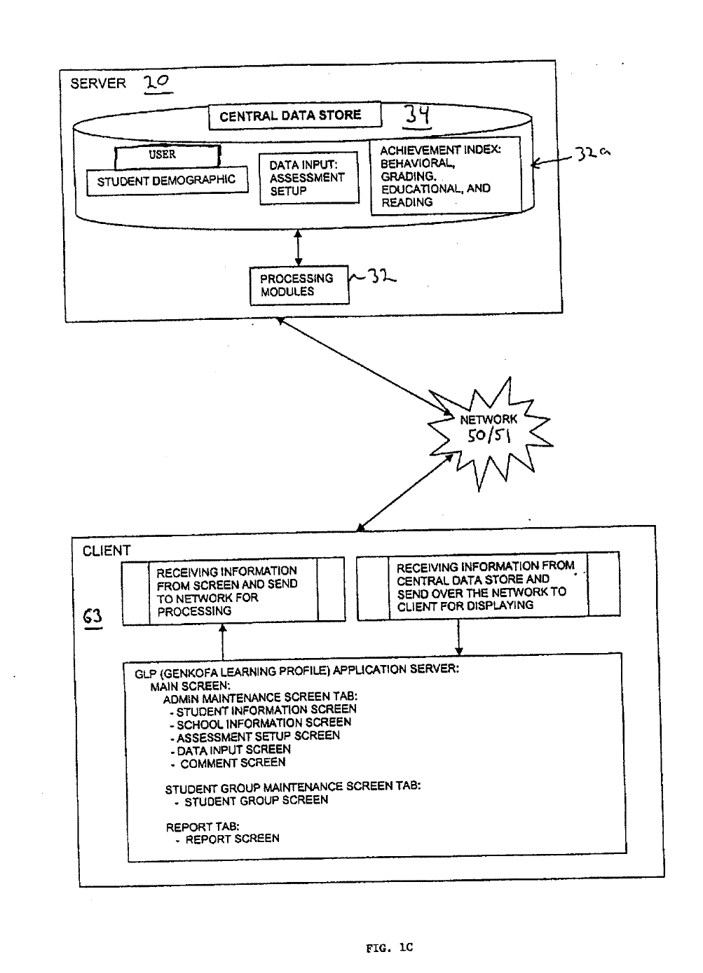

FIG. 1A discloses the system 10. The system is typically administered through a home server (HS) 20, which, as shown as a single server, may be one or more servers. Throughout this document, reference to a “server” includes a remote computer or remote computer system, or computer program therein, that is accessible over a communications medium, such as the Local Area Network (LAN) 50 or Wide Area Network (WAN) 51 (a public network, such as the Internet), that provides services to other computer programs (and their users), in the same or other computers.

The home server (HS) 20 typically includes a Student Data Archive (SDA) module 22, that is in electronic communication with a database 24 for SDA data, and a Genkofa Learning Profile (GLP) module 32, that is in electronic communication with a database 34 for GLP data. The SDA module 22 and corresponding database 24 define an administrative or “Front Desk” sub system, that is operable in accordance with the SDA User Manual, attached hereto as Appendix B. The GLP module 32 and corresponding database 34 define a sub system for determining an index score for each student, whose data is in the system, that is operable in accordance with the GLP User Manual, attached hereto as Appendix C.

The various users of the system 40-48n, are linked to communications networks, such as a local area network (LAN) 50, or a wide area network (WAN) 51 (a public network, such as the Internet), by wired or wireless electronic an/or data links, or combinations, so as to be in electronic and/or data communication with the home server (HS) 20 (for illustration purposes, the home server (HS) has a uniform resource locator of www.hs.com). These users 40-48n enter data into the system (if permitted to do so by the rules and policies of the system), as represented by the home server (HS) 20, that is used for its operation, in calculating the index scores, and other processes disclosed herein.

The users, typically include a system administrator 40, who is in charge of the disclosed system (as administered by the home server (HS) 20. Users also include teachers 41 (of everyday subjects, reading, mathematics, science, social studies, penmanship, history, etc.) and other instructional personnel 42 (specialist teachers and the like that see students when necessary or at regular intervals, such as art, music, physical education), other educational staff 43, such as guidance counselors, therapists, librarians, and the like, school administrators and school officials 44, such as principals, disciplinarians, truant officers, as well as district, regional, state or federal personnel, as represented by the user 45. Other LAN users 46a, as well as WAN users 46b are also permissible, as permitted access by the rules and policies of the disclosed system. Parents and guardians of students 47 may also access the system, typically through the Wide Area Network 51, for example, the Internet. Also, all of the aforementioned users 40-46a, can access the home server (HS) 20 through the WAN 51, and are represented as users 48a-48n (“n” being the last of an indeterminate series of users).

The various users 40-48n are permitted access to various portions (modules) of the system, and their ability to use the system, entering and viewing data, accessing and printing data, reports and the like, is in accordance with the rules and policies for the users or their user groups, as programmed into the system.

FIGS. 1B and 1C show the modules 22, 22a, 32, 32a (and their associated data bases 24, 34, respectively) of the system of the home server (HS) 20, in detail. Also shown is the linking of the home server (HS) 20 of the disclosed system to clients 62, 63 associated with the computers of the various users 40-48n. In this document, a “client” is a requesting program or user in a client/server relationship. For example, the web browser associated with the computer of a user (such as users 40-48n) is a client in its relationship with the computer that is obtaining the requested file, for example, this computer here being the home server (HS) 20 (that is returning the requested file to the client).

The users, for example, those users represented by 40-48n may all be members of user groups, in order to have access to various modules, and databases and have been arranged into user groups with various security levels of the system. Example user groups may be as per the following table, where numbers relate to the various users described above and in FIG. 1A. For example, access to the various modules (FIGS. 1B and 1C) is on a read/write basis (except where indicated in the Table below) and data can be entered into the system for the requisite module and subject matter by the requisite user. The table is as follows.

GLP & SDA Security Level:

| User Group | Description of User Group | Security Level |
|---|---|---|
| 1 | Programming Administrator, | Super user; can access all |
| | System Administrator 40 | modules |
| 2 | Administrator, Users 44, 45 | Can access all modules |
| | (Dependent on System Rules and | except USER modules |
| | Policies) | |
| 3 | Admin Personnel, | Can access all modules |
| | Users 44, 45 (Dependent on System | except USER, Class |
| | Rules and Policies) | Schedule, Grade, and |
| | | Transcript modules |
| 4 | Teacher Personnel, Users 41, 42 | Teacher Phone Log module only |
| 5 | Counselor, User 43 | Mental Health Assessment |
| | | module and run reports only |
| 6 | Executive Personnel (principal, | Can run all Reports and |
| | executive director), User 44 | additional Mental Health |
| | | Assessment reports |
| 7 | Personnel, Users 46a, 46b, 47 | Can access to Parent |
| | | Volunteer module only |

In the table above, the number of the user group, e.g., 1-7, is a field in files 1001 and 2001, with the description of the user group a field in files 1000, 1001, 2000 and 2001.

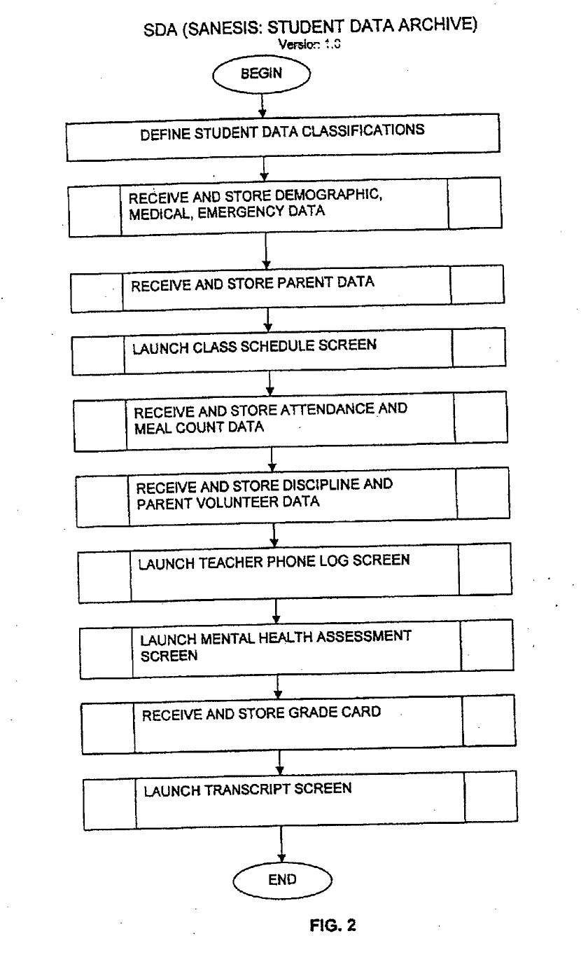

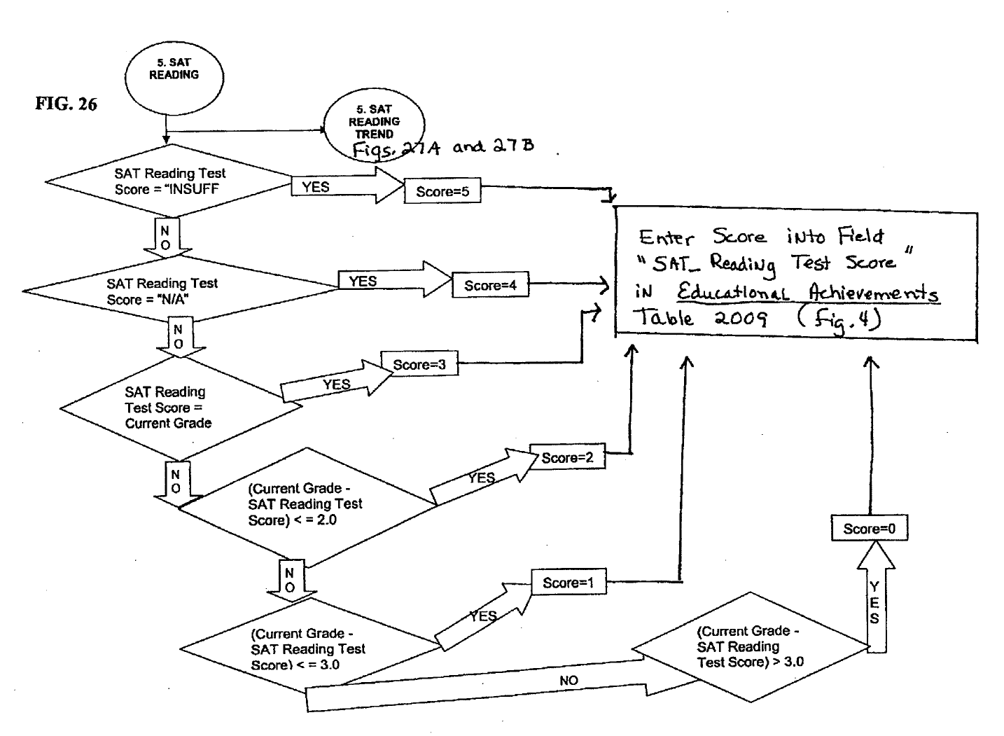

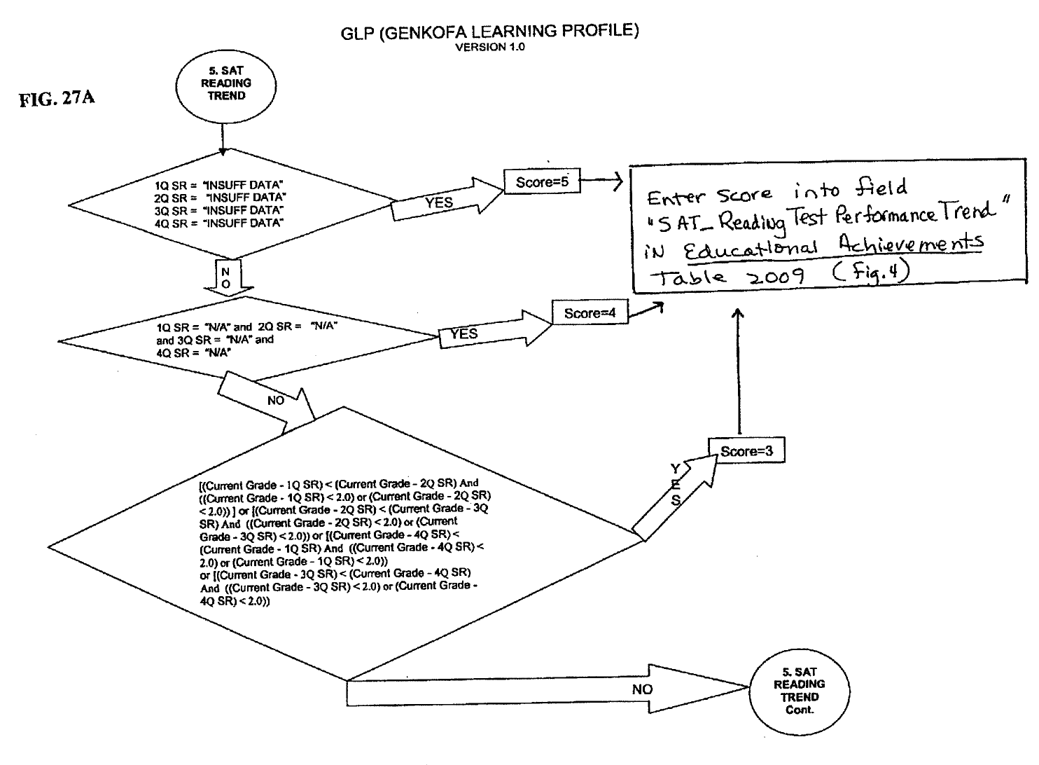

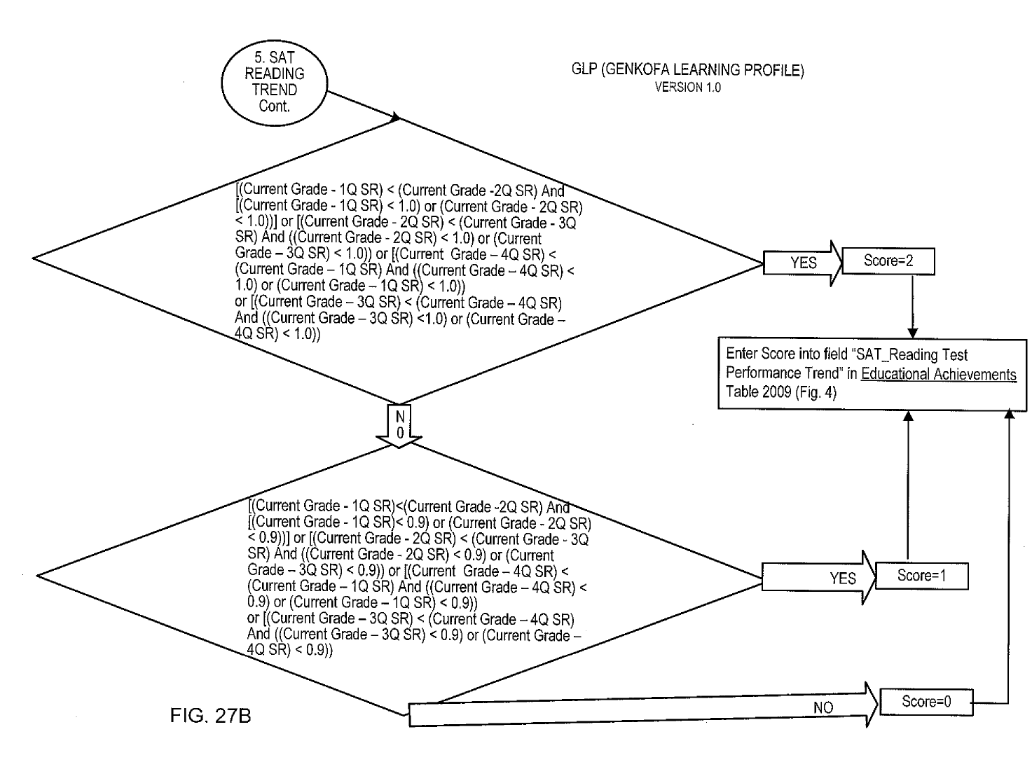

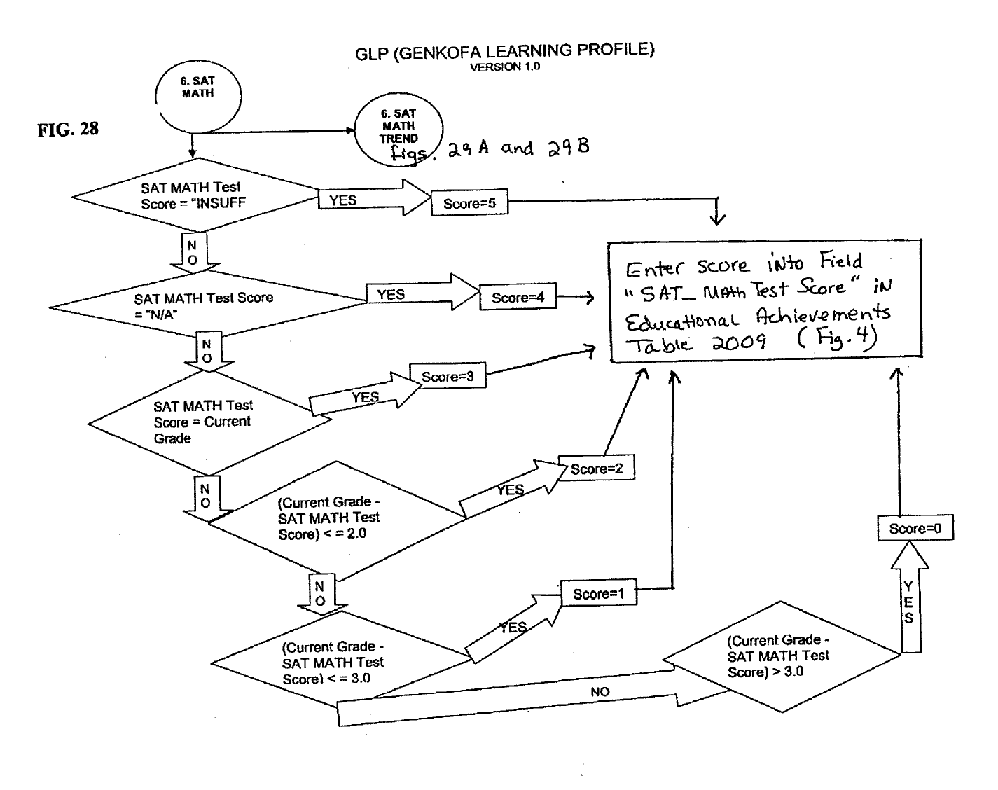

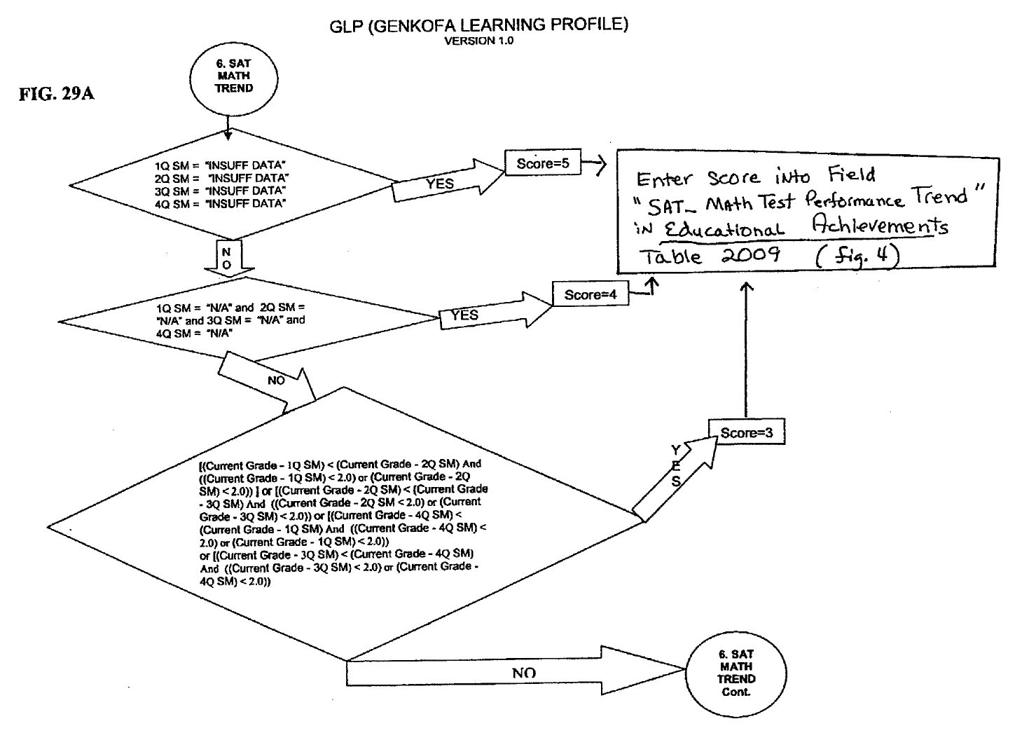

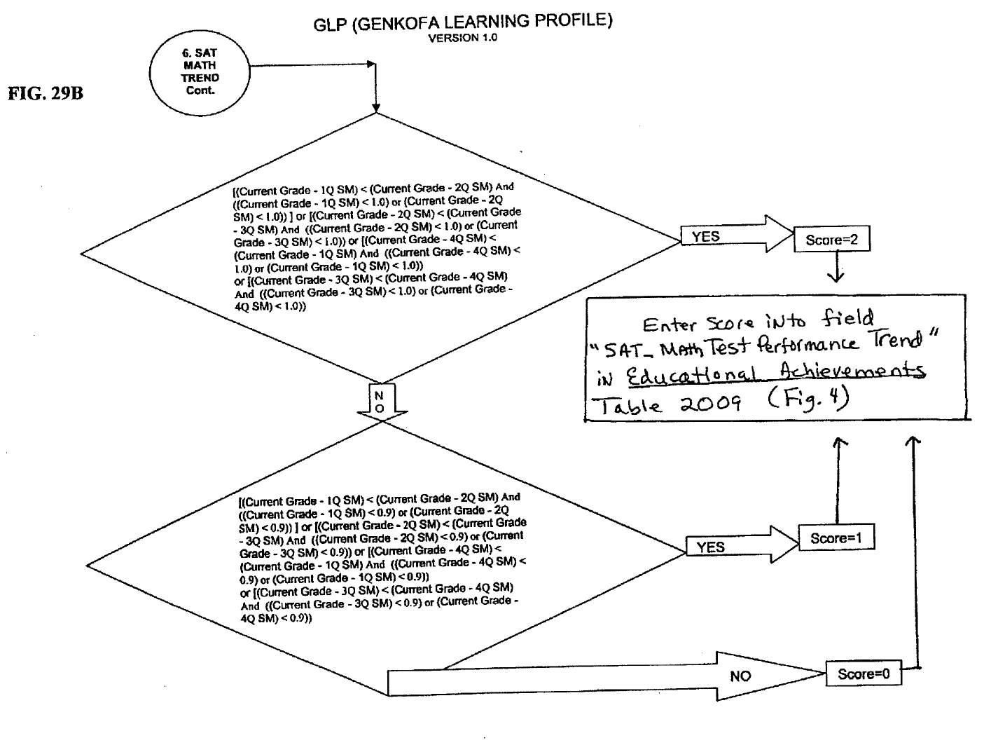

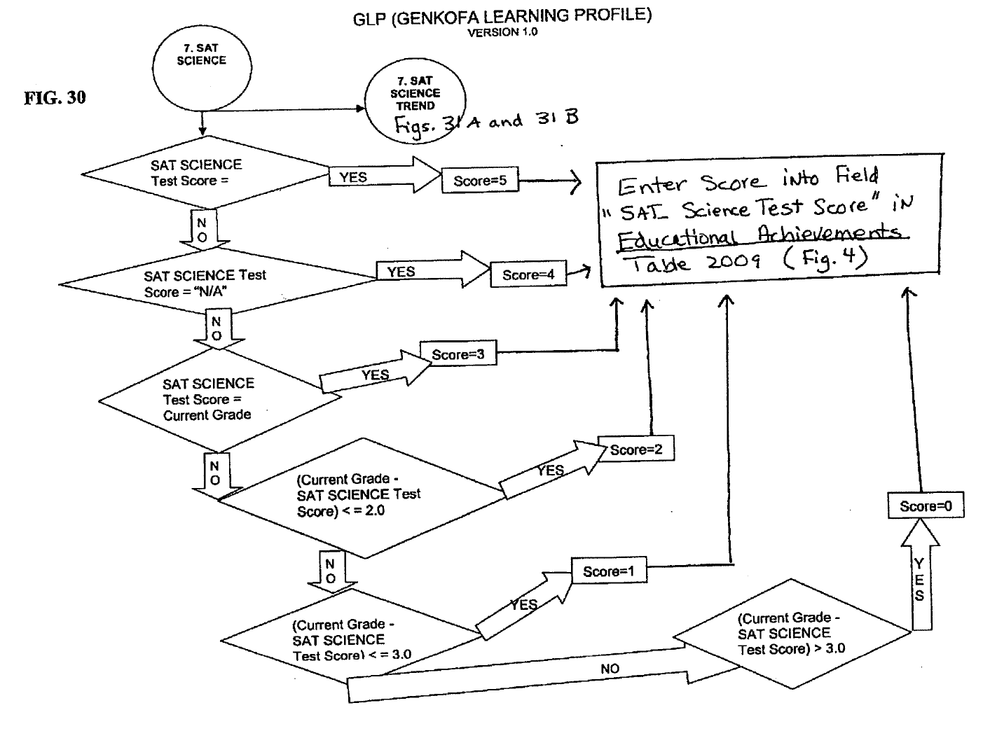

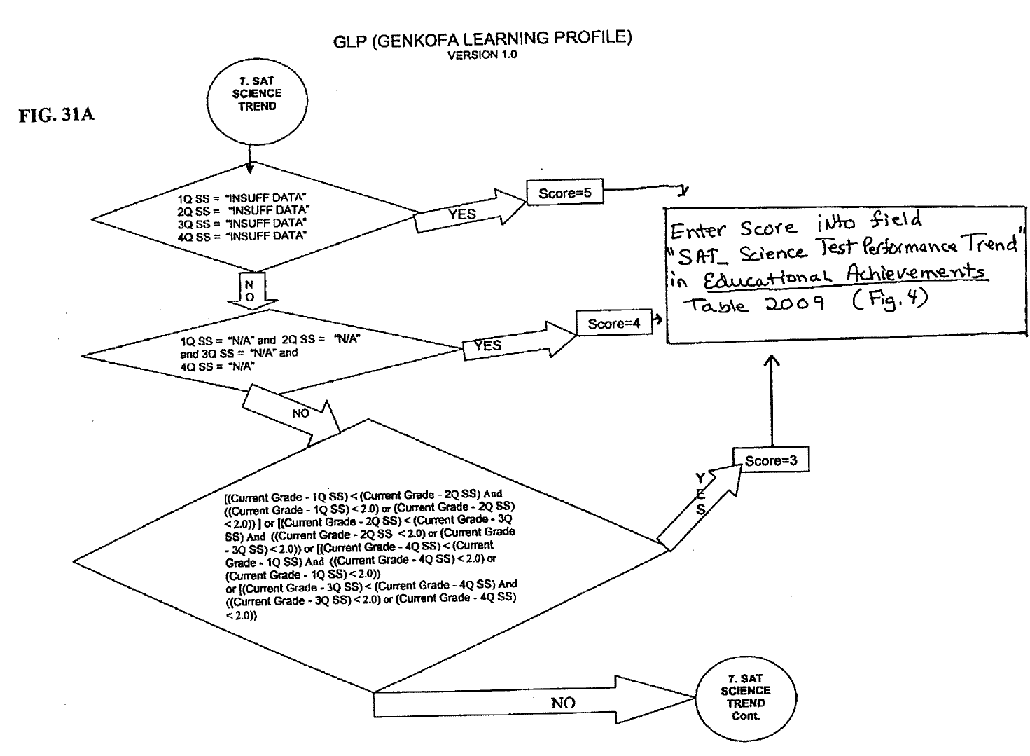

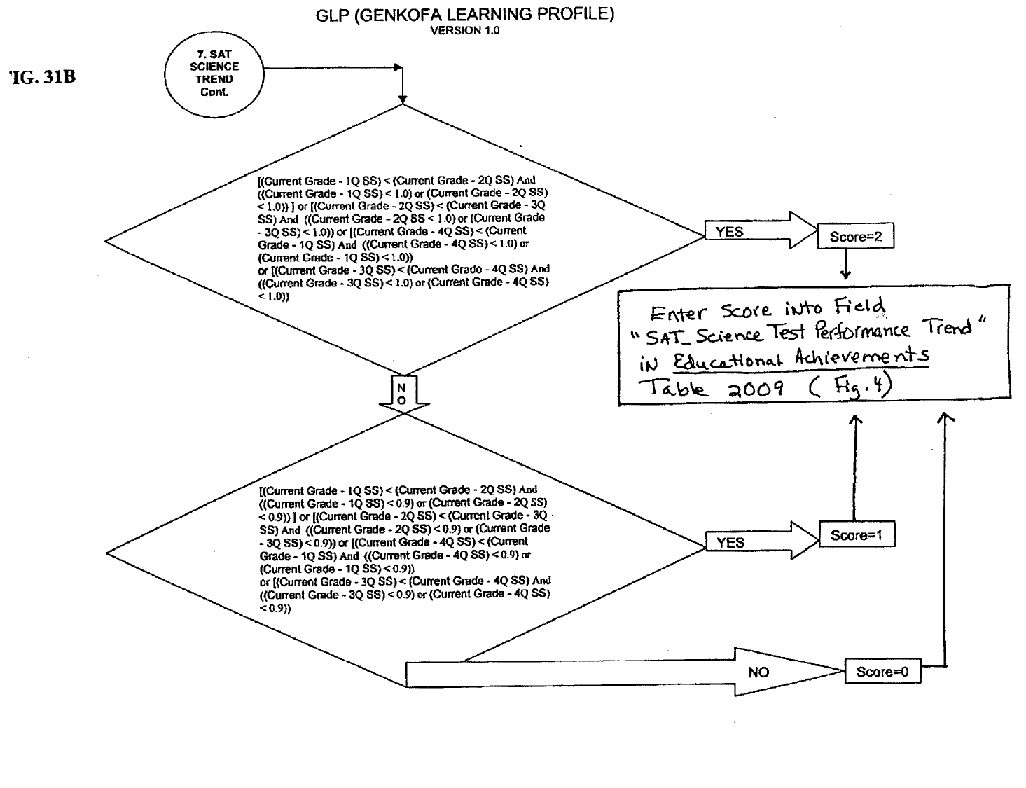

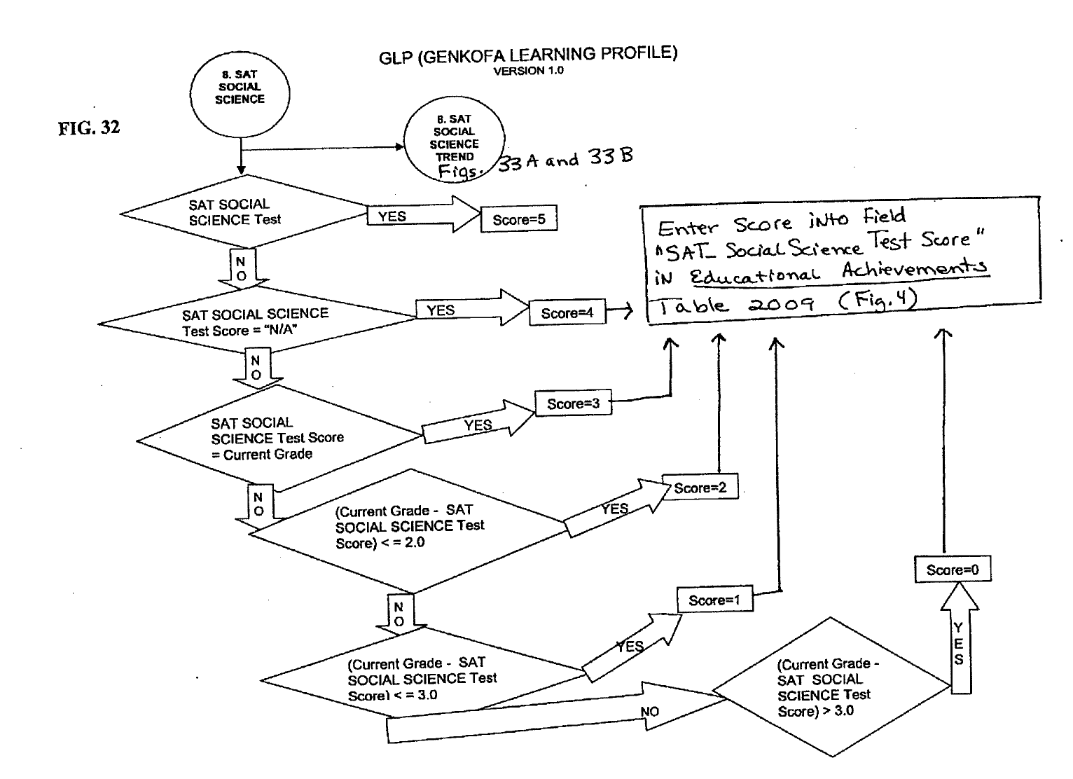

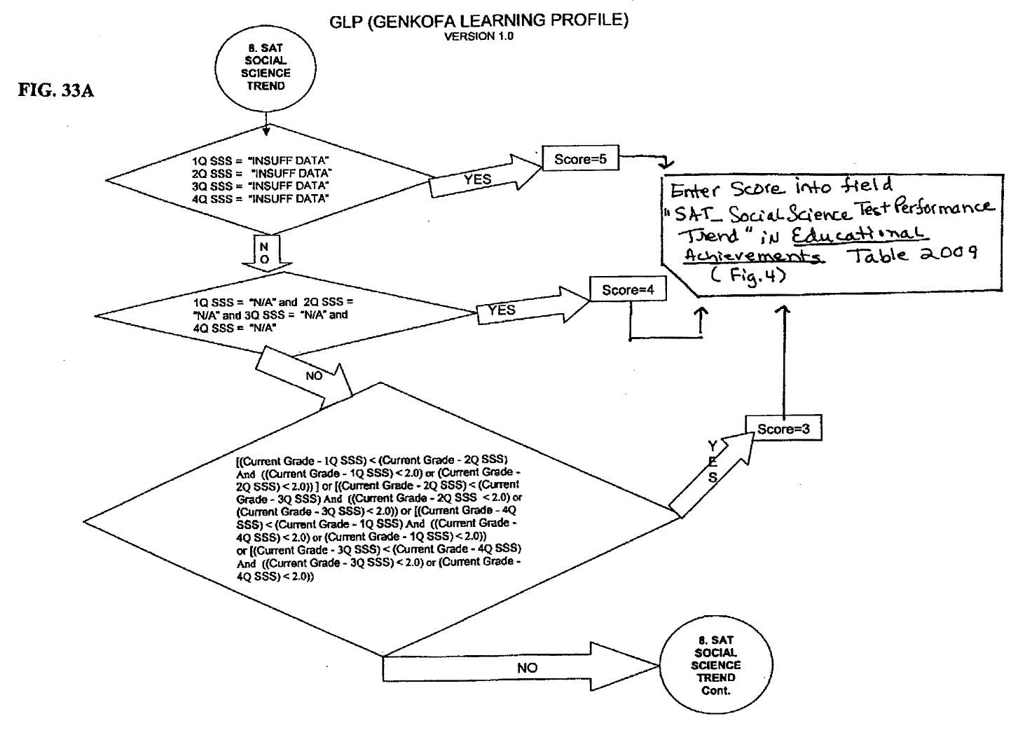

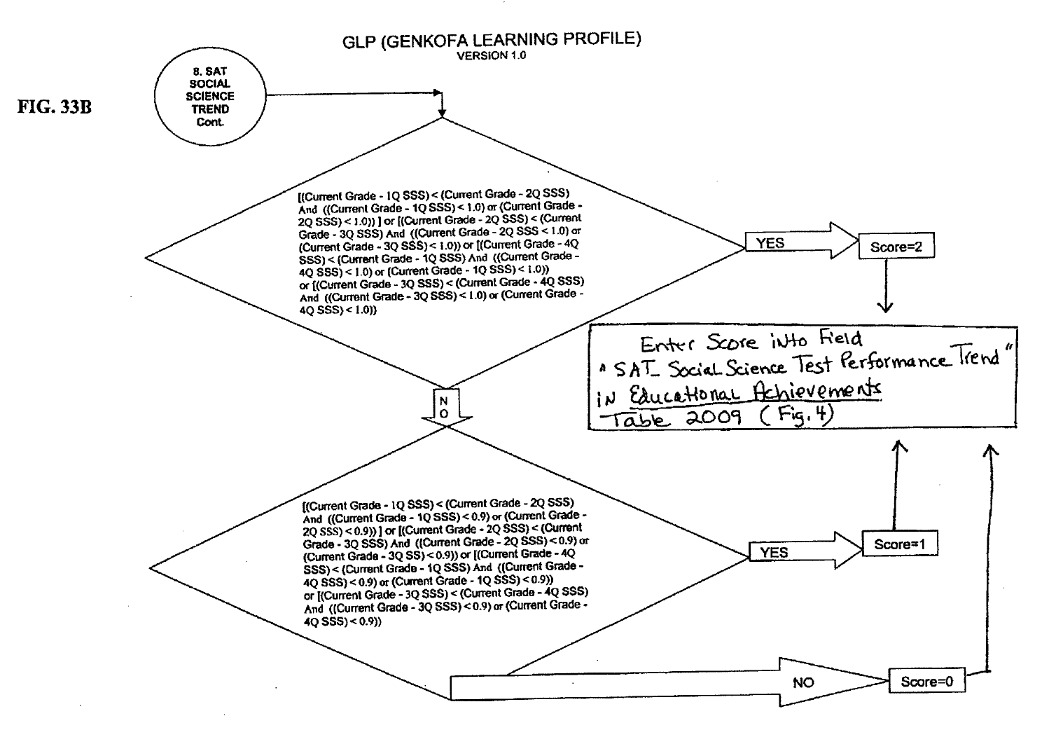

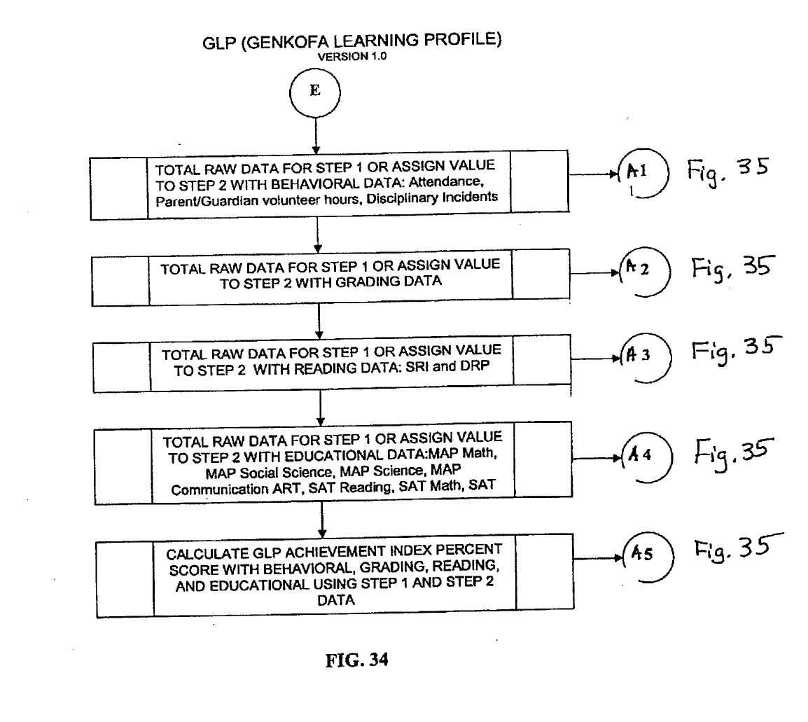

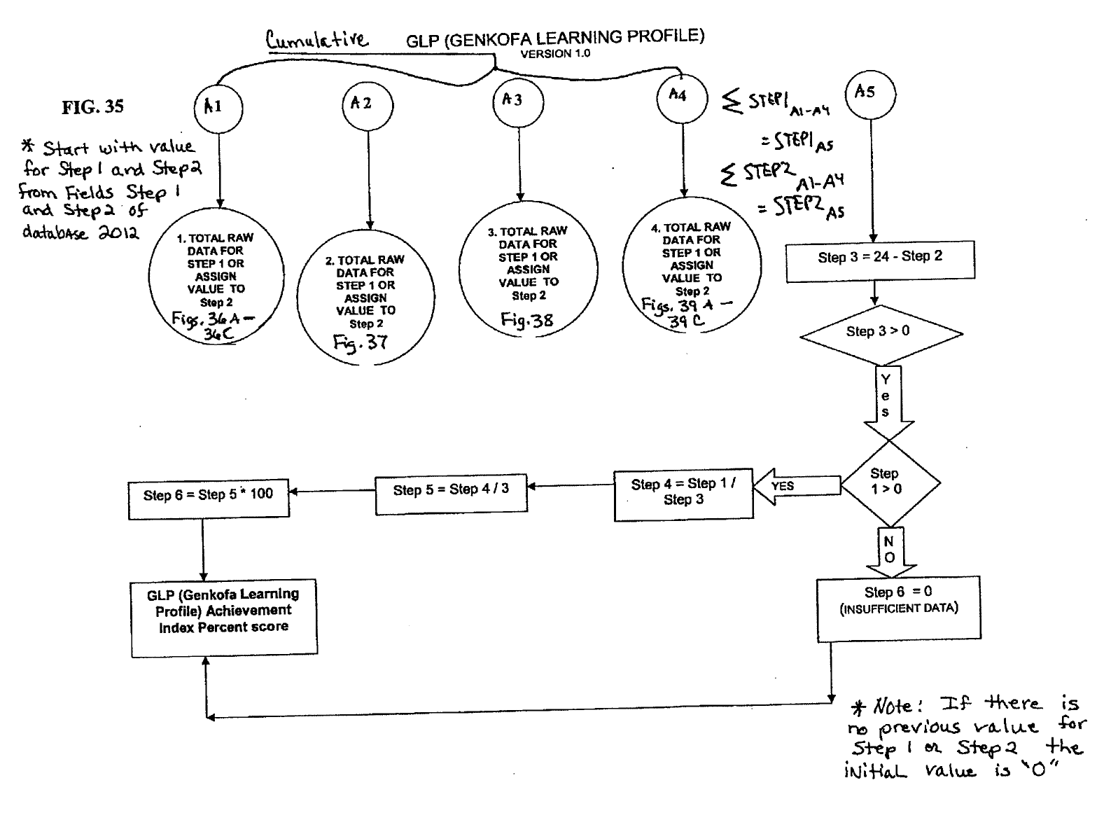

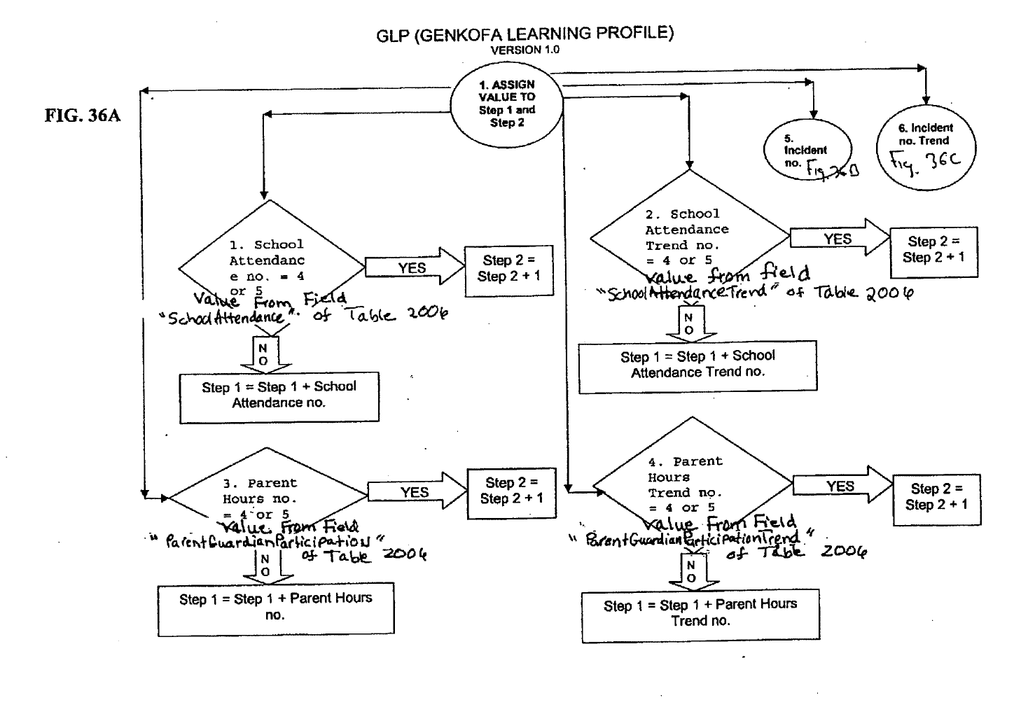

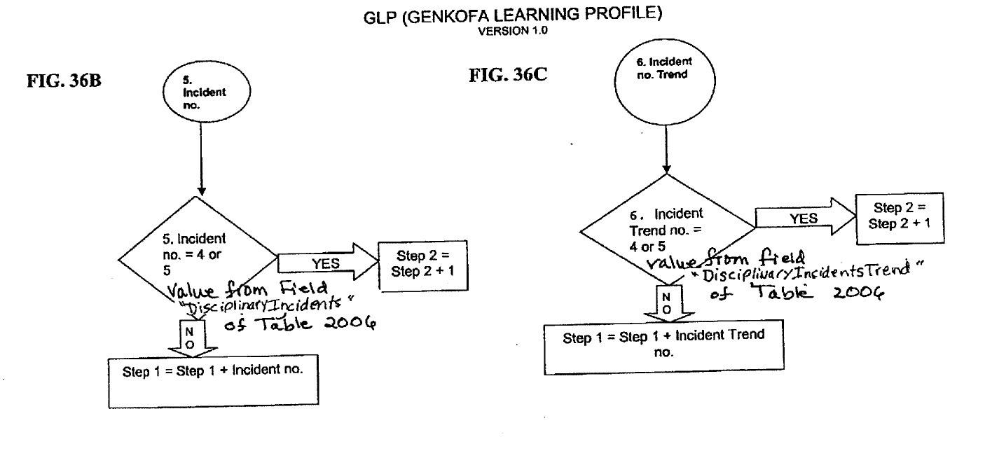

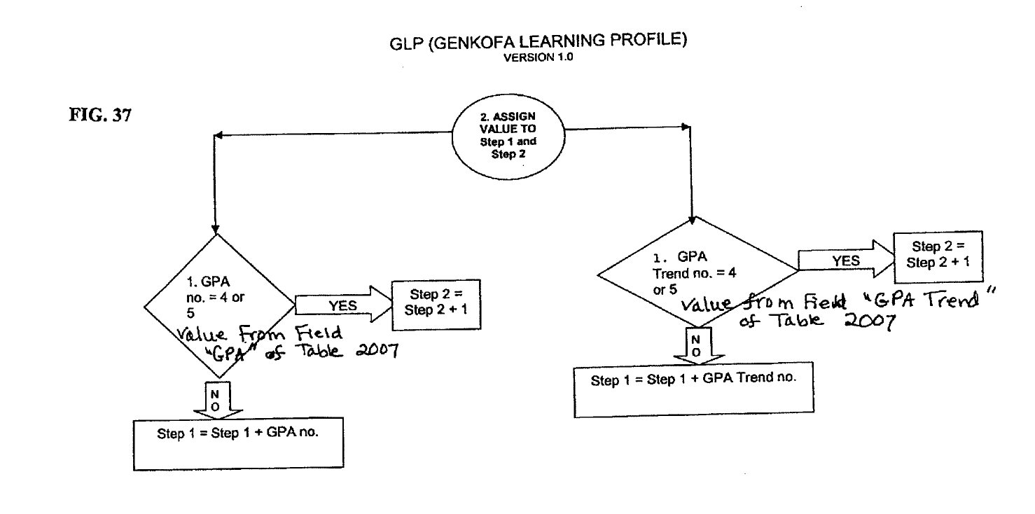

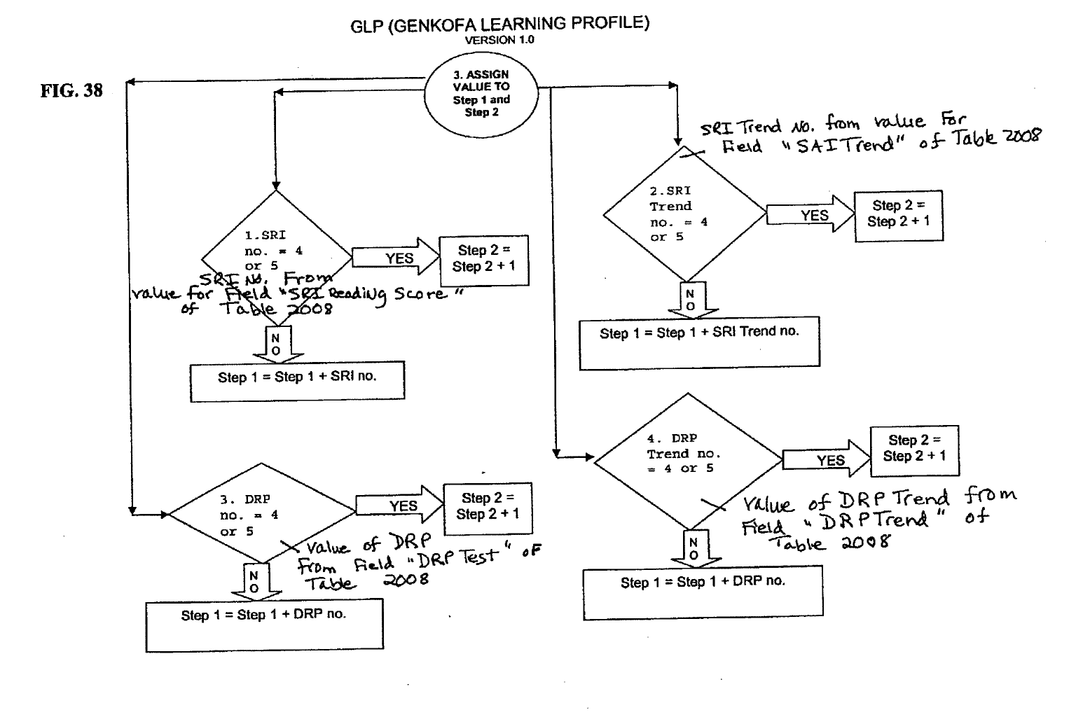

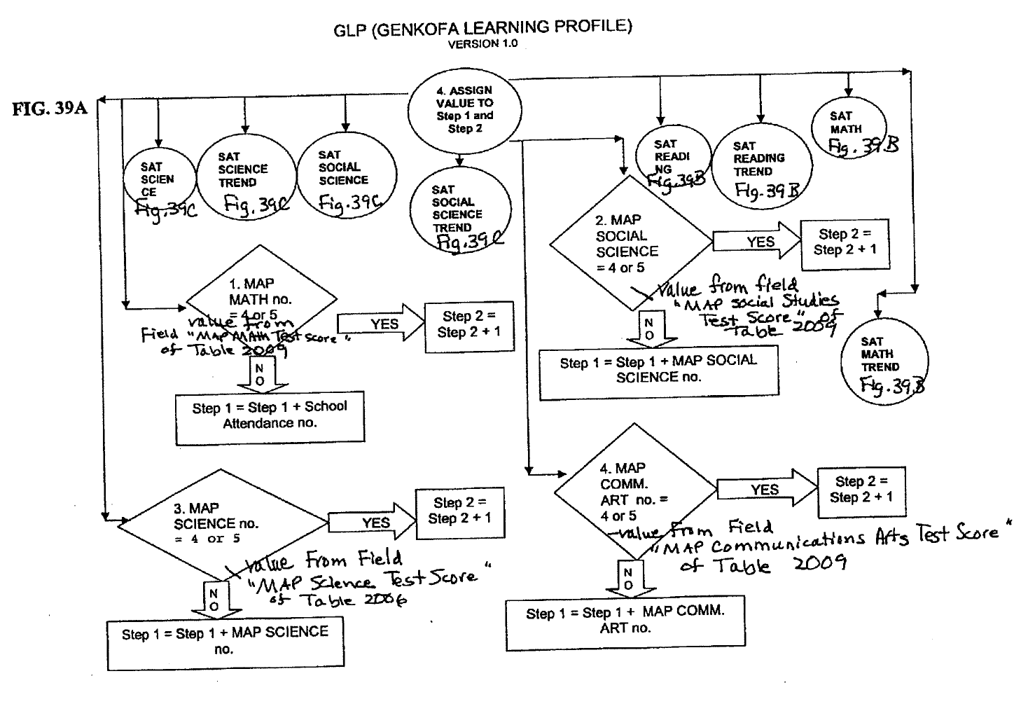

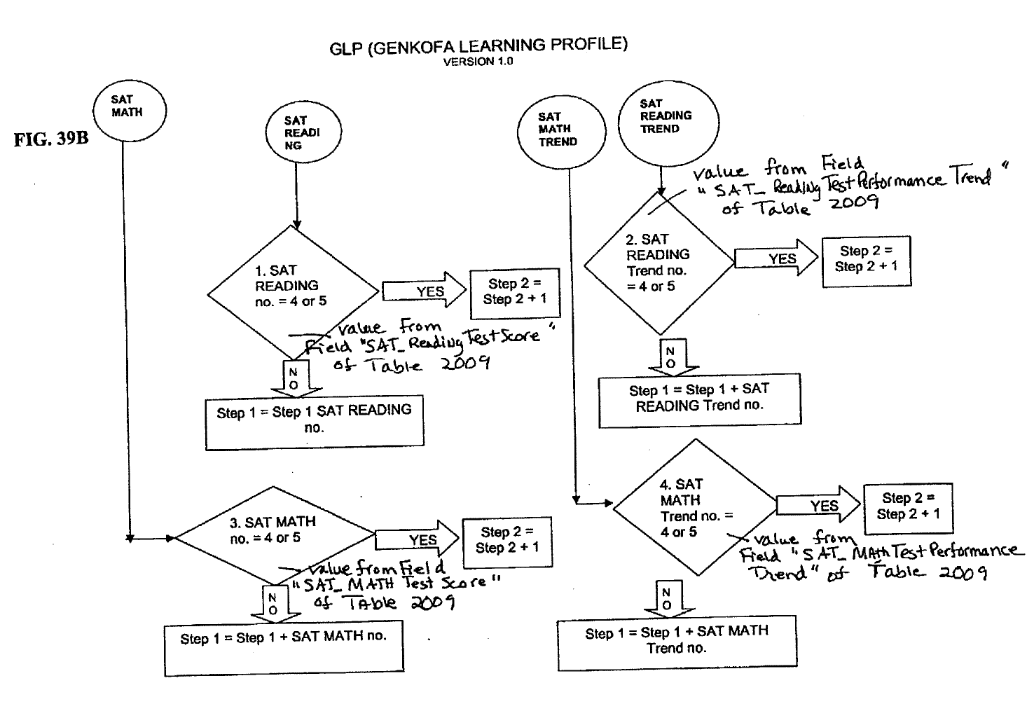

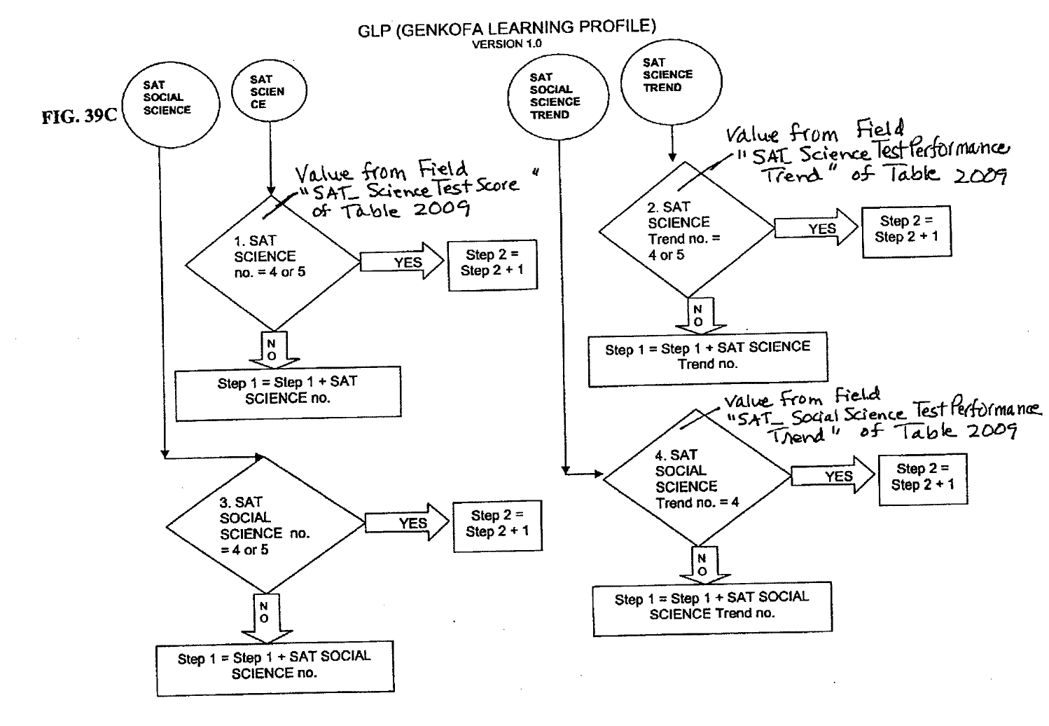

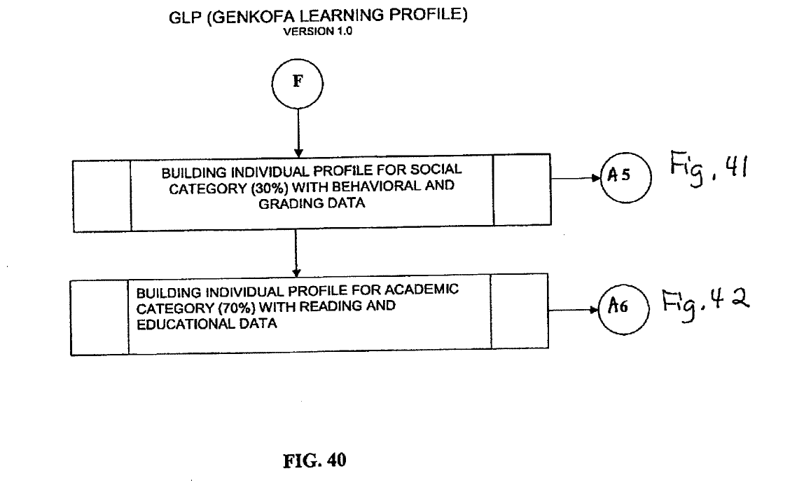

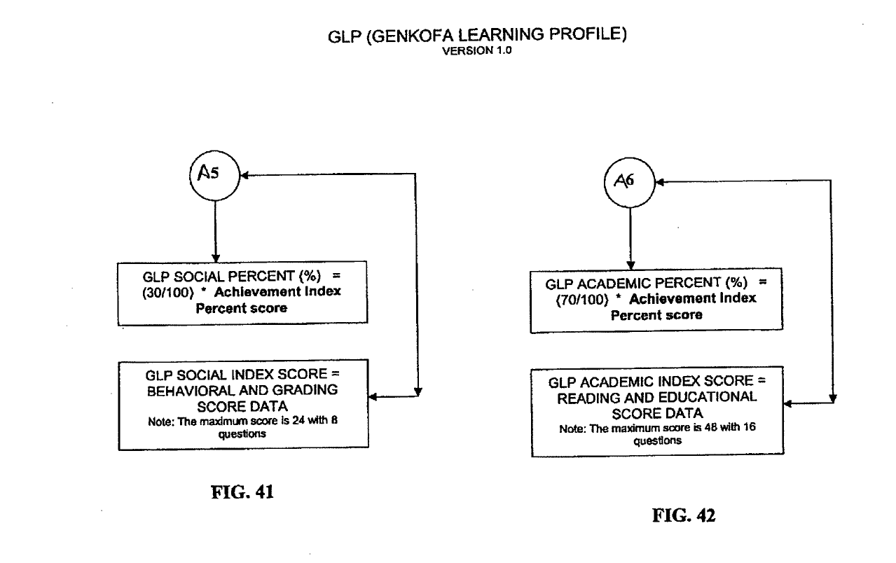

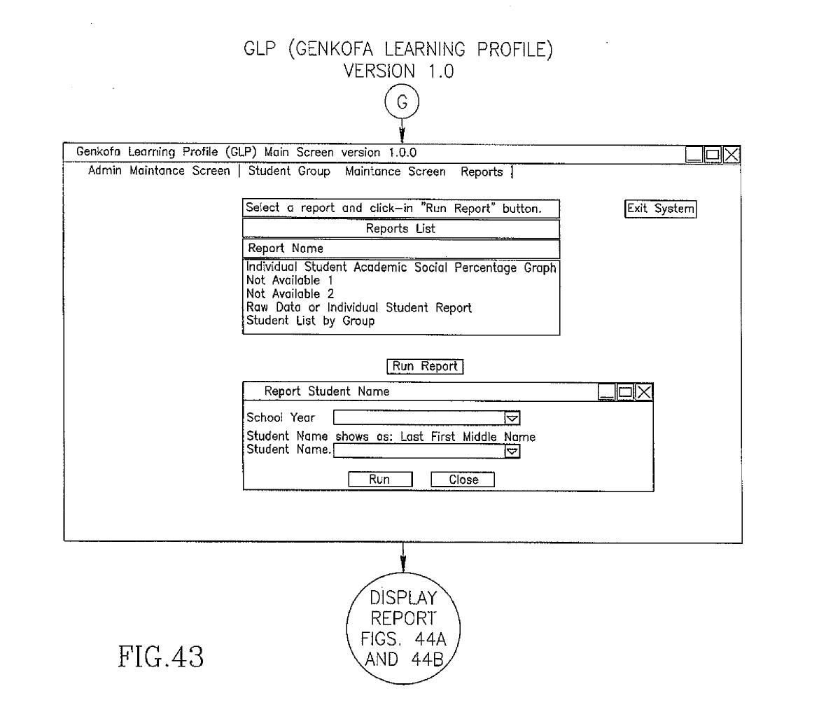

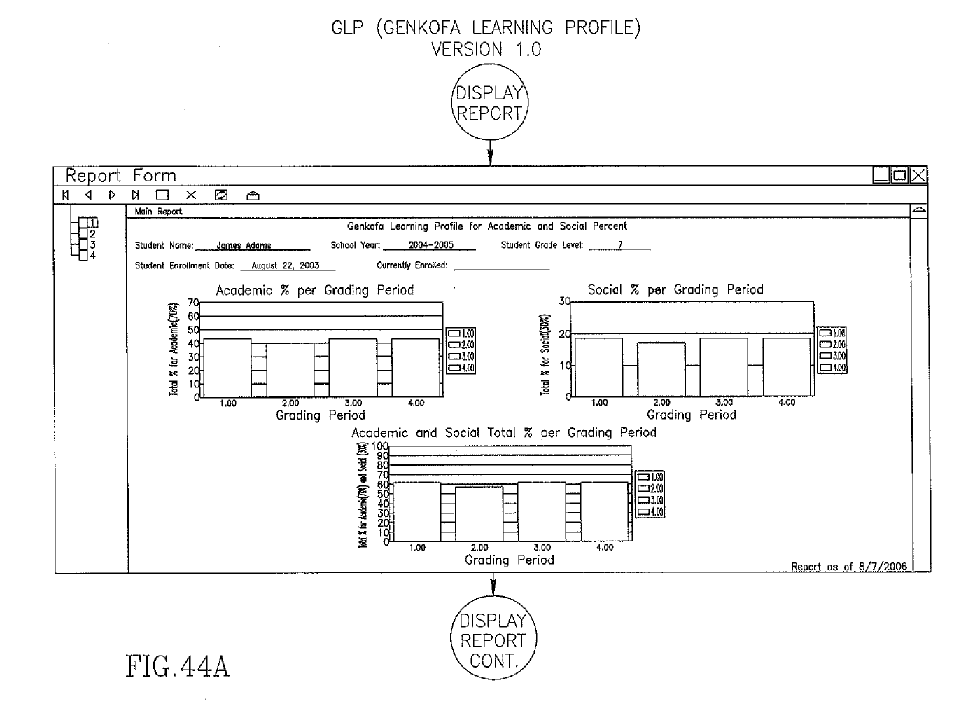

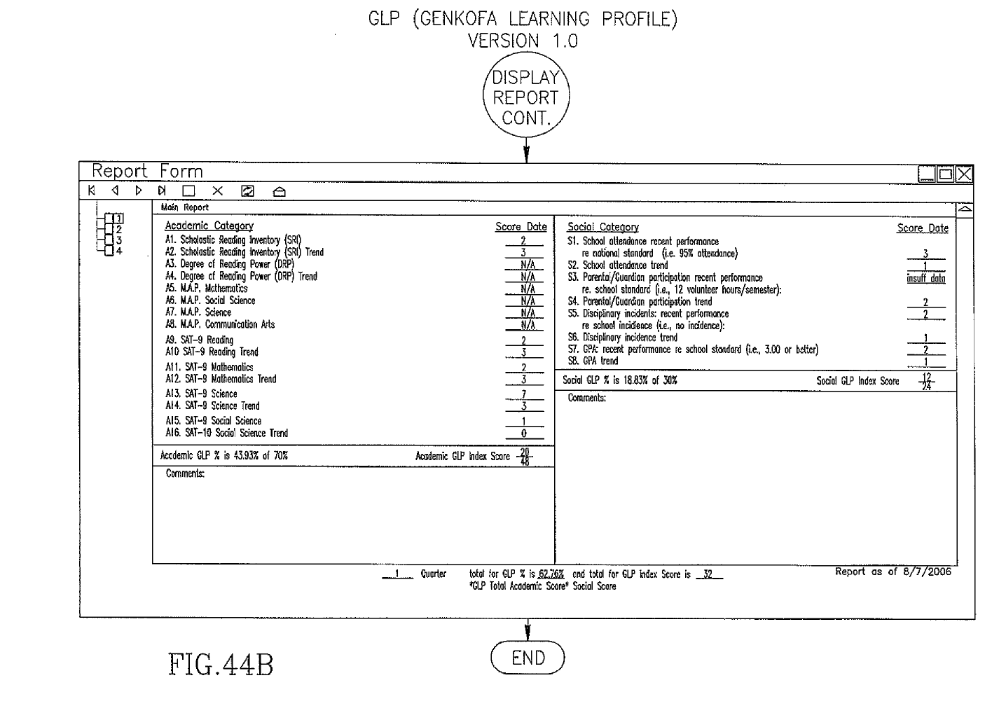

FIG. 2 to FIG. 44B disclose a method, that, for example, uses the system of FIGS. 1A-1C, for calculating the index score of each student, for whom data has been entered into the system, as represented by the home server (HS) 20. The index score, for each student is documentation of the achievement and needs of each individual student. It is based on a learning community's (a learning community being for example, one or more schools) goals. The index score individually measures each student to improve on academic growth and social deficiencies, and is used as a tool for review and analysis by care teams, for example, composed of teachers, counselors, and other school administrators and personnel.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

### Appendix A

### Files for SDA and GLP Databases

### 37 Sheets

SDA TABLES
Login - 1000

| Field | Description |
|---|---|
| UserID | User Identification |
| Password | Password for User |
| FirstName | First name of User |
| LastName | Last name of User |
| UserCreated | Name of user who created this file |
| DateCreated | Date file was created |
| Usergroup | Group which the user is a member of |

SDA TABLES
User Group - 1001

| Field | Description |
|---|---|
| Usergroup | Number of User Group |
| Description | Description of User Group |
| UserID | User Identification |
| DateCreated | Date file was created |

SDA TABLES
Parent Account - 1002

| Field | Description |
|---|---|
| Parent_Account_ID | Parent Account Identification |
| Active_Indicator | Status Indicator Active/Inactive |
| LastName | Last name of parent |
| FirstName | First name of parent |
| MiddleName | Middle name of parent |
| Address | Address of parent |
| Address2 | Address of parent - extra line |
| City | City of address |
| State | State of address |
| ZipCode | Zip code of address |
| Home_Phonenumber | Home telephone number |
| Cell_Phonenumber | Cellular telephone number |
| ConsentforRecords_Indicator | Consent for records Yes/No |
| ParentGuardian | Parent or guardian |
| Relationship | Relationship of parent or guardian to |
| | student |
| Address_if_Different | Address if it is different from address |
| | above |
| AddressIFD2 | Address - second line if it is different from |
| | above |
| CityIFD | City of address if it is different from above |
| StateIFD | State of address if it is different from |
| | above |
| ZipcodeIFD | Zip code of address if it is different from |
| | above |
| Application Status | Status of application active/inactive |
| MonthlyHouseIncome | Monthly household income |
| HouseHold_Size | Size of student's household |
| UserID | User Identification |
| DateCreated | Date file was created |
| LastUpdated | Date file was last updated |

SDA TABLES
Student Account - 1003

| Field | Description |
|---|---|
| Student_ID | Student Identification |
| Parent_Account_ID | Parent Account Identification |
| Teacher_ID | Teacher Identification |
| Student_SS_ID | Student Social Security Number |
| Student_State_ID | Student State Identification |
| LastName | Student Last Name |
| FirstName | Student First Name |
| MiddleName | Student Middle Name |
| NickName | Student Nickname |
| Ethnic | Ethnicity of Student |
| Gender | Gender of Student |
| Active | Is this file active (Yes/No) |
| Contract | Is there a contract involved? (Yes/No) |
| Billable_Contract | Is this contract billable? (Yes/No) |
| Grade | Grade of Student |
| LunchCode | Lunch Code |
| Birthday | Birth date of Student |
| BusNumber | Number of bus student takes |
| Bus_Pickup | Is student bussed to school (Yes/No) |
| Parent_Pickup | Does parent pick student up at school |
| | (Yes/No) |
| SummerSchool | Does student attend summer school |
| | (Yes/No) |
| SaturdaySchool | Does student attend school on Saturday |
| | (Yes/No) |
| IEP | Individual Evaluation Plan |
| Application_Date | Date of Application |
| Application_AcceptedDate | Date Application was accepted |
| Application_Status | In process/Accepted/Not Accepted |
| Previous_School | Name of previous school |
| PS_StartDate | Previous school start date |
| PS_EndDate | Previous school end date |
| PS_ReasonCode | Code for reason for leaving previous |
| | school |
| PS_Address | Street address of previous school |
| PS_City | City of previous school |
| PS_State | State of previous school |
| PS_Zipcode | Zip code of previous school |
| PS_ContractPhone | Telephone number of previous school |
| Comments | Comments |
| Withdrawal_Date | Date student withdraw from previous |
| | school |
| Withdrawal_Code | Code for student withdrawal |
| Student_Picture | Student picture in database (Yes/No) |
| UserID | User Identification of person who created |
| | this file |
| DateCreated | Date file was created |
| LastUpdated | Date file last updated |

SDA TABLES
Medical Info - 1004

| Field | Description |
|---|---|
| Student_ID | Student Identification |
| Medical_History | Medical history (Yes/No) |
| Medicaid_ID | Medical Identification No. |
| Allergies | List of allergies |
| Medical_Insurance | Name of medical insurance provider & |
| | policy no. |
| Asthma | Asthma (Yes/No) |
| Inhaler | Inhaler (Yes/No) |
| Diabetic | Diabetic (Yes/No) |
| Comments | Comments |
| HepB1 | Hepatitis B shots (Yes/No) |
| HepB2 | Hepatitis B shots (Yes/No) |
| HepB3 | Hepatitis B shots (Yes/No) |
| HepB4 | Hepatitis B shots (Yes/No) |
| DTaP1 | DTaP1 shots (Yes/No) |
| DTaP2 | DTaP2 shots (Yes/No) |
| DTaP3 | DTaP3 shots (Yes/No) |
| DTaP4 | DTaP4 shots (Yes/No) |
| DTaP5 | DTaP5 shots (Yes/No) |
| Td | Td shots (Yes/No) |
| Hib1 | Hib1 shots (Yes/No) |
| Hib2 | Hib2 shots (Yes/No) |
| Hib3 | Hib3 shots (Yes/No) |
| Hib4 | Hib4 shots (Yes/No) |
| IPV1 | IPV1 shots (Yes/No) |
| IPV2 | IPV2 shots (Yes/No) |
| Polio1 | Polio vaccine (Yes/No) |
| Polio2 | Polio vaccine (Yes/No) |
| Polio3 | Polio vaccine (Yes/No) |
| Rv1 | Rv1 shots (Yes/No) |
| Rv2 | Rv2 shots (Yes/No) |
| Rv3 | Rv3 shots (Yes/No) |
| MMR1 | Mumps Measles Rubella vaccine (Yes/No) |
| MMR2 | Mumps Measles Rubella vaccine (Yes/No) |
| MMR3 | Mumps Measles Rubella vaccine (Yes/No) |
| Var1 | Var1 shots (Yes/No) |
| Var2 | Var1 shots (Yes/No) |
| UserID | User Identification |
| DateCreated | Date file was created |
| LastUpdated | Date file last updated |

SDA TABLES
Emergency Info - 1005

| Field | Description |
|---|---|
| E_ContactName1 | Emergency contact name |
| E_ContactPhone1A | Emergency contact phone number |
| E_ContactPhone1B | Emergency contact phone number |
| E_ContactPhone1C | Emergency contact phone number |
| E_ContactPhone1D | Emergency contact phone number |
| E_ContactName2 | Second emergency contact name |
| E_ContactPhone2A | Second emergency contact phone number |
| E_ContactPhone2B | Second emergency contact phone number |
| E_ContactPhone2C | Second emergency contact phone number |
| E_ContactPhone2D | Second emergency contact phone number |
| E_ContactName3 | Third emergency contact name |
| E_ContactPhone3A | Third emergency contact phone number |
| E_ContactPhone3B | Third emergency contact phone number |
| E_ContactPhone3C | Third emergency contact phone number |
| E_ContactPhone3D | Third emergency contact phone number |
| PhysicianName | Name of student's physician |
| OfficePhoneNumber | Physician's office phone number |
| PreferredHospital | Preferred hospital |
| Location | Location of preferred hospital (address) |
| UserID | User Identification |
| DateCreated | Date file was created |
| LastUpdated | Date file last updated |

SDA TABLES
Student Class Schedule - 1006

| Field | Description |
|---|---|
| Student_ID | Student Identification |
| SchoolYear | School Year |
| GradingPeriod | Grading Period |
| ScheduleGroup1 | Monday & Tuesday class schedule |
| Reflections | Reflection |
| CampClass1_1 | Camp class 1 |
| CampClass2_1 | Camp class 2 |
| CampClass3_1 | Camp class 3 |
| Core1_Mon_Tues | Core 1 class for Monday and Tuesday |
| Core2_Mon_Tues | Core 2 class for Monday and Tuesday |
| Lunch1_Mon_Tues | Lunch period for Monday & Tuesday |
| ScheduleGroup2 | Wednesday & Thursday class schedule |
| Core3_Wed_Thrs | Core 3 class for Wednesday & Thursday |
| Core4_Wed_Thrs | Core 4 class for Wednesday & Thursday |
| Lunch2_Wed_Thrs | Lunch period for Wednesday & Thursday |
| ScheduleGroupF | Friday class schedule |
| Lunch3_Fri | Lunch period for Friday |
| SpecialProjects | Special Project class |
| SpecialProject2 | Special Project class 2 |
| UserID | User Identification |
| DateCreated | Date file created |
| LastUpdated | Date file last updated |

SDA TABLES
Class - 1007

| Field | Description |
|---|---|
| class_id | Class identification (numerical) |
| class_name | Class name |
| room_num | Room number |
| class_type | Class type |
| class_size | Class size |
| teacher_id | Teacher identification (numerical) |
| UserID | User Identification of person who created |
| | this file |
| DateCreated | Date file was created |
| LastUpdated | Date file last updated |

SDA TABLES
Class Hour - 1008

| Field | Description |
|---|---|
| class_hour_description | Name of period (e.g. First Period) |
| class_hour | Number of period (e.g., 1) |
| UserID | User Identification |
| DateCreated | Date file was created |

SDA TABLES
Student Attendance - 1009

| Field | Description |
|---|---|
| Student_ID | Student Identification |
| DailyAttendDate | Daily attendance with date |
| Teacher_ID | Teacher identification |
| WeekNumber | Week number |
| SchoolYear | School year |
| GradingPeriod | Grading period |
| LunchCode | Identification Lunch State (free/reduced/ |
| | fully paid by student) |
| DailyAttendHours | Hours in school daily |
| AbsentHours | Hours absent in school |
| EarlyDismissalHours | Hours dismissed early |
| TardyHours | Hours tardy |
| AbsentCode | Codes for various absences (e.g., sick, |
| | suspended, etc.) |
| Eat_Lunch | Does student eat lunch at school (Yes/No) |
| Eat_Breakfast | Does student eat breakfast at school |
| | (Yes/No) |
| UserID | User Identification |
| DateCreated | Date file was created |
| LastUpdated | Date file last updated |

SDA TABLES
Discipline Guide Matrix - 1010

| Field | Description |
|---|---|
| discipline_no | Discipline Number |
| incident_no | Total Number of incidents that student has |
| class_offense_no | Class offense number |
| discipline_result | Result of discipline |
| notification_letter | Notification letter sent (Yes/No) |
| suspension_letter | Notification letter sent (Yes/No) |
| isr_letter | In-School Retention Letter (Yes/No) |
| refocus_letter | Refocus letter sent (Yes/No) |
| nia_letter | Swope Park Health Center letter (Yes/No) |
| student_support_plan | Student support plan in place (Yes/No) |
| UserID | User Identification |
| DateCreated | Date file was created |
| LastUpdated | Date file last updated |

SDA TABLES
Offense - 1011

| Field | Description |
|---|---|
| offense_num | Offense number |
| offense_description | Description of offense |
| class | Class |
| UserID | User Identification of person who created |
| | this file |
| DateCreated | Date file was created |

SDA TABLES
Incident Info - 1012

| Field | Description |
|---|---|
| Student_ID | Student Identification |
| IncidentDate | Incident date |
| IncidentTime | Incident time |
| ReportBy | Person reporting incident |
| WhereistheIncident | Location of incident |
| SchoolYear | School Year |
| GradingPeriod | Grading Period |
| StaffComments | Staff comments |
| AdminComments | Administration comments |
| discipline_no | Discipline number |
| notification_send | Notification sent (Yes/No) |
| isr_send | In-School Retention Letter Sent (Yes/No) |
| nia_send | Swope Park Health Center letter Sent |
| | (Yes/No) |
| refocus_send | Refocus letter sent (Yes/No) |
| suspension_send | Suspension letter sent (Yes/No) |
| support_plan_send | Support plan sent (Yes/No) |
| class0 | Class Offense 0 |
| classI | Class Offense I |
| classII | Class Offense II |
| classIII | Class Offense III |
| classIV | Class Offense IV |
| UserID | User Identification |
| DateCreated | Date file was created |
| LastUpdated | Date file last updated |

SDA TABLES
Parent Volunteer Hours - 1013

| Field | Description |
|---|---|
| Student_ID | Student Identification |
| SchoolYear | School Year |
| GradingPeriod | Grading Period |
| Volunteer_Date | Date of volunteering |
| Volunteer_Name | Volunteer name |
| Volunteer_TimeIn | Volunteer time in |
| Volunteer_TimeOut | Volunteer time out |
| Total_Hours | Volunteer total hours |
| Volunteer_Activity | Description of activity for volunteer |
| UserID | User Identification of person who created |
| | file |
| LastUpdated | Date file last updated |

SDA TABLES
Mental Health Screen Assessment - 1014

| Field | Description |
|---|---|
| Student_ID | Student Identification |
| SchoolYear | School Year |
| GradingPeriod | Grading Period |
| MH_Date | Mental Health Assessment Date |
| Provider_Name | Provider name |
| Suicidal_Thoughts | Student - Suicidal thoughts (Yes/No) |
| Suicidal_Plan | Student - Suicidal plan (Yes/No) |
| Medical_Problems | Student - Medical problems (Yes/No) |
| Alcohol_Problems | Student - Alcohol problems (Yes/No) |
| Drug_Problems | Student - Drug problems (Yes/No) |
| Evidence_Thought_Disorder | Student - Evidence of thought disorder |
| | (Yes/No) |
| Homicial_Thought | Student - Homicidal thoughts (Yes/No) |
| Homicidal_Plans | Student - Homicidal plans (Yes/No) |
| Presenting_Problems_Duration | Student - How long has student |
| | presented problems? |
| Current_Situation | Student - current situation comments |
| Pertinent_History | Pertinent history for student |
| Assessment | Assessment of student |
| Diagnosis_Axis_I | Diagnosis |
| Diagnosis_Axis_II | Diagnosis |
| Diagnosis_Axis_III | Diagnosis |
| Diagnosis_Axis_IV | Diagnosis |
| Diagnosis_Axis_V | Diagnosis |
| Treatment_Plan_Solution | Treatment plan - solution (Yes/No) |
| Problem_Identified | Problem identified (Yes/No) |
| Strengths | Strengths |
| Limitations | Limitations |
| Initial_Treatment_Plan | Initial treatment plan (Yes/No) |
| Problems | Problems |
| Goals | Goals |
| Objectives | Objectives |
| Recomm_Intervention | Recommended intervention |
| Criteria_for_Termination | Criteria for termination |
| Staff_Notes | Notes from staff |
| UserID | User Identification of person who |
| | created this file |
| Created_Date | Date file was created |
| LastUpdated_Date | Date file last updated |

SDA TABLES
Group Therapy Log - 1015

| Field | Description |
|---|---|
| Student_ID | Student Identification |
| SchoolYear | School Year |
| GradingPeriod | Grading Period |
| GTL_Date | Group therapy date |
| Provider_Name | Provider name |
| Session_Topic | Session topic |
| a_attentive_group_process | Is student attentive? (Yes/No) |
| b_demo_understanding_topic | Is student understanding the topic? (Yes/No) |
| c_participated_activity_homework | Does student do homework? (Yes/No) |
| d_applied_topic_toown_experience | Has student applied the topic to his own |
| | experience? (Yes/No) |
| e_demo_insight | Does student demonstrate insight? |
| | (Yes/No) |
| f_positive_socialskill_interaction | Does student demonstrate social skills and |
| | interaction? (Yes/No) |
| g_expressed_emotion | Does student express emotion? (Yes/No) |
| h_accepted_responsibility | Does student accept responsibility (Yes/No) |
| i_appropriately_challenge_peer | Is student challenged by his peers? |
| | (Yes/No) |
| j_disruptive_group_process | Is student disruptive to the group process? |
| | (Yes/No) |
| k_sought_negative_attention | Does student seek negative attention? |
| | (Yes/No) |
| l_aggressive_verbally_physically | Is student aggressive verbally or |
| | physically? (Yes/No) |
| m_disrespectful_topeer_facilitator | Is student disrespectful to peers or |
| | facilitator? (Yes/No) |
| n_defiant_manipulative | Is student defiant or manipulative? (Yes/No) |
| summary | Summary |
| progress | Progress |
| UserID | User Identification of person who created this file |
| Created_Date | Date file was created |
| LastUpdated_Date | Date file last updated |

SDA TABLES
Student Grade - 1017

| Field | Description |
|---|---|
| Student_ID | Student Identification |
| SchoolYear | School Year |
| GradingPeriod | Grading Period |
| class_name | Class name |
| Attendance_25 | Attendance |
| Behavior_25 | Behavior |
| Participation_25 | Participation |
| ClassAssignment_25 | Class Assignment |
| teacher_id | Teacher identification |
| grade | Grade |
| point | Point |
| UserID | User Identification |
| Created_Date | Date file was created |
| LastUpdated_Date | Date file last updated |

SDA TABLES
Comment - 1016

| Field | Description |
|---|---|
| CommentID | Comment Identification |
| StudentkeyID | Student key identification |
| SchoolYear | School Year |
| GradingPeriod | Grading Period |
| Comment | Comment |
| CommentType | Type of comment |
| UserID | User Identification |
| UserLastUpdated | Name of user who last updated this file |
| DateCreated | Date file was created |
| LastUpdated | Date file last updated |

SDA TABLES
Transcript Comment - 1018

| Field | Description |
|---|---|
| Student_ID | Student Identification |
| SchoolYear | School Year |
| Comment | Comment |
| UserID | User Identification of person who created |
| | this file |
| LastUpdated_Date | Date file last updated |

GLP TABLES
Login - 2000

| Field | Description |
|---|---|
| UserID | User Identification |
| Password | Password for User |
| FirstName | First Name of User |
| LastName | Last Name of User |
| UserCreated | Person who created the user identification |
| DateCreated | Date file was created |
| Usergroup | Group which this user is a member of |

GLP TABLES
User Group - 2001

| Field | Description |
|---|---|
| Usergroup | Number of the Group |
| Description | Description of user group |
| UserID | User Identification |
| DateCreated | Date file was created |

GLP TABLES
Schools - 2002

| Field | Description |
|---|---|
| SchoolID | School Identification |
| SchoolStateID | Identification of state where school is |
| | located |
| SchoolName | Name of School |
| Address | Address of School |
| Address2 | Address of School - extra line |
| City | City where School is located |
| State | State where School is located |
| Zip | Zip Code |
| UserID | Identification of person who created this |
| | file |
| DateCreated | Date file was created |
| LastUpdated | Date file last updated |

GLP TABLES
State - 2003

| Field | Description |
|---|---|
| State | Two letter state abbreviation |
| StateLongName | Name of state - fully spelled out |

GLP TABLES
Comment - 2004

| Field | Description |
|---|---|
| CommentID | Key for this table |
| StudentkeyID | Student Identification key to limit student |
| | identification to Student_ID in Files 2005-2009 |
| | and 2012 |
| SchoolYcar | School Year |
| GradingPeriod | Grading Period |
| Comment | Comment |
| CommentType | Type of Comment |
| UserID | ID of User who made the comment |
| UserLastUpdated | User who updated this file |
| DateCreated | Date file was created |
| LastUpdated | Date file last updated |

GLP TABLES
Data Input - 2005

| Field | Description | | |
|---|---|---|---|
| Student_ID | Student Identification | | |
| SchoolYear | School Year | | |
| GradingPeriod | Grading Period | | |
| TotalDaysStudentEnrolled | Total number of days student was enrolled | | |
| | in school | | |
| TotalDaysSchoolwasinSession | Total no. of days school was in session | | |
| AttendanceRate | Attendance rate | | |
| ParentGuardianVolunteerHours | Total volunteer hours of parent or guardian | | |
| DisciplinaryIncidents | Disciplinary incidents of student | | |
| GPAs | Student GPA | | |
| SRI_GradeEquivalentScores | Scholastics Reading Inventory | | T |
| DRP_GradeEquivalentScores | Degree Reading Power | | E |
| MAP_MATH_Graders | Missouri Standard Test - Math | | S |
| MAP_SocialStudies_Graders | Missouri Standard Test - Social Studies | | T |
| MAP_Science_Graders | Missouri Standard Test - Science | | |
| MAP_CommunicationArts_Graders | Missouri Standard Test - Communication | | S |
| | Arts | | C |
| SAT_TotalReadingGELevel | Stanford Aptitude Test Total Reading | {close oversize bracket} | O |
| | General Level | | |
| SAT_TotalMathGELevel | Stanford Aptitude Test Total Math General | | R |
| | Level | | |
| SAT_ScienceGELevel | Stanford Aptitude Test Total Science | | E |
| | General Level | | |
| SAT_SocialScienceGELevel | Stanford Aptitude Test Total Social | | S |
| | Science General Level | | |
| UserID | User Identification | | |
| Created_Date | Date file created | | |
| LastUpdated_Date | Date file last updated | | |

GLP TABLES
Behavioral Measures - 2006

| Field | Description |
|---|---|
| Student_ID | Student Identification |
| SchoolYear | School Year |
| GradingPeriod | Grading Period |
| SchoolAttendance | Value defined by system for school |
| | attendance |
| SchoolAttendanceTrend | Value defined by system for school |
| | attendance trend |
| ParentGuardianParticipation | Value defined by system for parent/ |
| | guardian participation |
| ParentGuardianParticipationTrend | Value defined by system for parent/ |
| | guardian participation trend |
| DisciplinaryIncidents | Value defined by system for |
| | disciplinary incidents |
| DisciplinaryIncidentsTrend | Value defined by system for |
| | disciplinary incidents trend |
| UserID | User Identification |
| DateCreated | Date file was created |
| LastUpdated | Date file last updated |

GLP TABLES
Grading Measures - 2007

| Field | Description |
|---|---|
| Student_ID | Student Identification |
| SchoolYear | School Year |
| GradingPeriod | Grading Period |
| GPA | Value defined by system for GPA |
| GPATrend | Value defined by system for GPA trend |
| UserID | User Identification of Person who created |
| | this file |
| DateCreated | Date file was created |
| LastUpdated | Date file last updated |

GLP TABLES
Reading Achievement Measures - 2008

| Field | Description |
|---|---|
| Student_ID | Student Identification |
| SchoolYear | School Year |
| GradingPeriod | Grading Period |
| SRIReadingScore | Value defined by system for SRI reading |
| | score |
| SRITrend | Value defined by system for SRI trend |
| DRPTest | Value defined by system for DRP test |
| DRPTrend | Value defined by system for DRP trend |
| UserID | User Identification of person who created |
| | this file |
| DateCreated | Date file was created |
| LastUpdated | Date file last updated |

GLP TABLES
Educational Achievements - 2009

| Field | Description |
|---|---|
| Student_ID | Student Identification |
| SchoolYear | School Year |
| GradingPeriod | Grading Period |
| MAPMathTestScore | Value defined by system for |
| | Missouri Standardized Test |
| MAPSocialStudiesTestScore | Value defined by system for |
| | Missouri Standardized Test |
| MAPScienceTestScore | Value defined by system for |
| | Missouri Standardized Test |
| MAPCommunicationArtsTestScore | Value defined by system for |
| | Missouri Standardized Test |
| SAT_MathTestScore | Value defined by system for |
| | Missouri Standardized Test |
| SAT_MathTestPerformanceTrend | Value defined by system for |
| | Missouri Standardized Test |
| SAT_ReadingTestScore | Value defined by system for |
| | Missouri Standardized Test |
| SAT_ReadingTestPerformanceTrend | Value defined by system for |
| | Missouri Standardized Test |
| SAT_ScienceTestScore | Value defined by system for |
| | Missouri Standardized Test |
| SAT_ScienceTestPerformanceTrend | Value defined by system for |
| | Missouri Standardized Test |
| SAT_SocialScienceTestScore | Value defined by system for |
| | Missouri Standardized Test |
| SAT_SocialScienceTestPerforTrend | Value defined by system for |
| | Missouri Standardized Test |
| UserID | User Identification of person who |
| | created this file |
| DateCreated | Date file was created |
| LastUpdated | Date file last updated |

GLP TABLES
Assessment Setup - 2010

| Field | Description |
|---|---|
| SchoolYear | School Year |
| A1 | Response to Assessment Questions |
| A2 | See FIG. 8 |
| A3 | See FIG. 8 |
| A4 | See FIG. 8 |
| A5 | See FIG. 8 |
| A6 | See FIG. 8 |
| A7 | See FIG. 8 |
| A8 | See FIG. 8 |
| A9 | See FIG. 8 |
| A10 | See FIG. 8 |
| A11 | See FIG. 8 |
| A12 | See FIG. 8 |
| A13 | See FIG. 8 |
| A14 | See FIG. 8 |
| A15 | See FIG. 8 |
| A16 | See FIG. 8 |
| UserCreated | Name of user who created the file |
| LastUpdated | Date file last updated |

GLP TABLES
Report - 2011

| Field | Description |
|---|---|
| ReportName | Name of Report |
| DateCreated | Date Report was created |

GLP TABLES
Achievement Index - 2012

| Field | Description | |
|---|---|---|
| Student_ID | Student Identification | |
| SchoolYear | School Year | |
| GradingPeriod | Grading Period | |
| Step1 | Score - Step 1 of process | |
| Step2 | Score - Step 2 of process | |
| Step3 | Score - Step 3 of process | |
| Step4 | Score - Step 4 of process | {close oversize bracket} |
| Step5 | Score - Step 5 of process | |
| Step6 | Score - Step 6 of process | |
| UserID | User Identification of person who | |
| | created the file | |
| Created_Date | Date file was created | |
| LastUpdated_Date | Date file last updated | |

GLP TABLES
Assessment - 2013

| Field | Description |
|---|---|
| AssessmentID | Assessment Identification |
| AssessmentType | Type of assessment |
| UserCreated | Name of user who created this file |
| DateCreated | Date file was created |

What is claimed is:

1. A method for evaluating the progress of a student comprising:
receiving achievement data for the student including classes of data comprising behavioral data, grade data, reading proficiency data, and standardized test score data;
processing the achievement data to generate an individual achievement index score for each of the classes of data; and
building a learning profile for the student from the index score data, wherein the behavioral data and the grade data are together classified as social data, and the reading proficiency data and the standardized test score data are together classified as academic data;
generating social and academic index scores for the student, wherein the social data and the academic data are weighted in accordance with corresponding predetermined parameters; and
summing the weighted social and academic data to yield a score indicative of the performance of the student during a particular period of time.

2. The method of claim 1, including the step of tabulating the individual achievement index scores using at least two categories including a first category for the social data and a second category for the academic data, in accordance with the learning profile.

3. The method of claim 1, wherein the step of processing the achievement data to generate an individual achievement index score includes:
calculating summed raw data scores for each of the categories of the achievement data; and
normalizing the summed raw scores in accordance with predetermined criteria.

4. The method of claim 1, wherein the step of building a learning profile further includes tabulating, for successive periods of time, for successive periods of time, achievement data tabulated into categories representing the social data and the academic data, indicative of a performance history of the student.

5. The method of claim 1, including the step of generating a report including the individual achievement index score wherein items in the learning profile are sorted by periods related to school sessions attended by the student.

6. The method of claim 1, including the step of displaying, for successive periods of time, categories of the achievement data including the social data and the academic data, indicative of a performance history of the student.

7. The method of claim 1, including the step of displaying the individual achievement index score using two categories including a first category for the social data and a second category for the academic data, in accordance with the learning profile

8. The method of claim 1, wherein the behavioral data includes class attendance and grade point average data for the student.

9. The method of claim 1, wherein the social data includes information related to the family of the student.

10. The method of claim 1, wherein the grade data consists of grade point average data.

11. The method of claim 1, wherein the step of processing the achievement data comprises generating the individual achievement index score with respect to the behavioral data by using data including grade point average, school attendance, disciplinary incidents, and parent/guardian volunteer time.

12. The method of claim 1, wherein the step of processing the achievement data comprises generating trending data by comparing grade point average, class attendance data, disciplinary incident data, and parent/guardian volunteer time for successive periods of time.

13. A method for evaluating the progress of a student comprising:
receiving achievement data for the student including classes of data comprising behavioral data, grade data, reading proficiency data, and standardized test score data;
processing the achievement data to generate an individual achievement index score for each of the classes of data;
building a learning profile for the student from the index score data, wherein the behavioral data and the grade data are together classified as social data, and the reading proficiency data and the standardized test score data are together classified as academic data; and
weighting the social data and the academic data in accordance with respective predetermined multipliers to generate corresponding social and academic index scores for the student.

14. The method of claim 13, including summing the weighted social and academic data to yield a net index score indicative of the performance of the student during a particular period of time.

15. The method of claim 13, including displaying, for successive periods of time, achievement data tabulated into categories representing the social data and the academic data, indicative of a performance history of the student.

16. The method of claim 13, including displaying the individual achievement index scores using two categories including a first category for the social data and a second category for the academic data, in accordance with the learning profile.

17. The method of claim 13, wherein the behavioral data includes class attendance and grade point average data for the student.

18. The method of claim 13, wherein the grade data consists of grade point average data.

19. The method of claim 13, wherein the step of processing the achievement data comprises generating the individual achievement index score with respect to the behavioral data by using data including grade point average, school attendance, disciplinary incidents, and parent/guardian volunteer time.

20. The method of claim 13, wherein the step of processing the achievement data comprises generating trending data by comparing grade point average, class attendance data, disciplinary incident data, and parent/guardian volunteer time for successive periods of time.

21. The method of claim 13, wherein the social data includes information related to the family of the student.

22. A system for evaluating the progress of a student comprising:
a database for storing achievement data for the student including behavioral data, grade data, reading proficiency data, and standardized test score data; and
a computer, coupled to the database, which performs tasks including:
processing the achievement data to generate an individual achievement index score;
building a learning profile for the student from the achievement data, wherein the behavioral data and the grade data are together classified as social data, and the reading proficiency data and the standardized test score data are together classified as academic data, wherein the social data and the academic data are weighted in accordance with predetermined parameters; and
tabulating the individual achievement index score using at least two categories including a first category for the social data and a second category for the academic data, in accordance with the learning profile.

23. The system of claim 22, wherein processing the achievement data comprises generating trending data by comparing grade point average, class attendance data, disciplinary incident data, and parent/guardian volunteer time for successive periods of time.

24. The system of claim 22, wherein the step of processing the achievement data to generate an individual achievement index score includes:
calculating summed raw data scores for each of the categories of the achievement data; and
normalizing the summed raw scores in accordance with predetermined criteria.

25. The system of claim 22, wherein the computer builds the learning profile by tabulating, for successive periods of time, categorized achievement data including the social data and the academic data, indicative of a performance history of the student.

26. The system of claim 22, wherein the behavioral data includes class attendance and grade point average data for the student.

27. A method for evaluating educational progress of a student including:
recording test results of a standardized test taken by the student;
recording day-to-day academic performance of the student;
recording social data related to the student;
weighting and summing the test results, the classroom results and the social data in accordance with respective predetermined criteria to determine an index score, and
making educational recommendations for the student based on the index score.

28. The method of claim 27, wherein the social data includes information related to the family of the student.
